(19) United States
(12) Patent Application Publication
(10) Pub. No.: US 2011/0278324 A1
(43) Pub. Date: Nov. 17, 2011

(54) LUBRICATION WORK CENTER

(76) Inventors: Michael Tony Kilian, Montgomery, IL (US); Gary Richard Kilian, Montgomery, IL (US)

(21) Appl. No.: 13/107,705

(22) Filed: May 13, 2011

Related U.S. Application Data
(60) Provisional application No. 61/395,602, filed on May 14, 2010.

(51) Int. Cl. B67D 7/06; B67D 7/84; B67D 7/62; B67D 7/76; B67D 7/70; B67D 7/78

(52) U.S. Cl. 222/135; 222/145.5; 222/108; 137/355.17; 222/1; 222/173; 222/189.06; 222/23

(57) ABSTRACT

Systems and methods for storing, dispensing, and working with fluids are disclosed. Embodiments include modular systems designed to facilitate pre-assembled shipping and system reconfiguration. Embodiments further include color-coding and shape-coding of various items and labels to reduce confusion and mistakes.

### CROSS-REFERENCE AND PRIORITY CLAIM TO RELATED PATENT APPLICATIONS

This application claims priority to provisional patent application 61/395,602 filed May 14, 2010, and entitled “Lubrication Work Center”, the entire disclosure of which is incorporated herein by reference.

### BACKGROUND AND SUMMARY OF THE INVENTION

It is often necessary for businesses to store a variety of fluids in factories and other facilities, and transfer these fluids from various stages of bulk storage to various intermediate vessels for moving some quantity of a fluid to other locations. For example, consider a machine on a factory floor that requires regular application of a particular type of oil. A worker goes to the bulk storage container for the required oil, transfers a quantity to an intermediate container, carries the intermediate container and fluid to the machine on the factory floor, and applies the oil to the machine at a designated oil application point. This process presents an opportunity for a variety of mistakes. For example, a facility may include a number of different machines each having individual fluid requirements. In turn, the facility would include bulk storage for a number of different fluids. Moreover, a machine may require a plurality of fluids, each with one or more designated application points. A worker may become confused with respect to (1) what fluid is required by a particular machine, (2) what fluid is currently contained in a particular bulk storage container or intermediate container, or (3) which application point on a particular machine corresponds to which fluid. The above list is merely a cursory overview of the many opportunities for confusion in the storage, selection, and application of fluids in, e.g., an industrial facility.

Another issue for end-users of work stations, fluid dispensing stations, and fluid containment systems is the requirement of assembly, and the various disadvantages thereof, including the costs of time, delay, labor and financial cost, and the opportunity for mistake and confusion inherent in assembly. Prior art systems are delivered to the user in many pieces and require substantial assembly. In addition to initial assembly, a facility operator may wish to subsequently re-configure a work station, fluid dispensing station, or fluid storage system (or any combination thereof). Prior art systems are not designed to facilitate reconfiguration.

Ergonomics is another issue for end-users of work stations, fluid dispensing stations, and fluid containment systems. Prior art systems generally fail to provide a user-friendly experience.

Yet another issue in facilities that use fluids is spillage. Spillage results in waste of the fluid, waste of time and delay required by the clean-up process. Spilled fluid may also present a hazard to people in the facility, which raises various legal issues for employers when employees are exposed to hazardous chemicals. Spilled fluid may also present an environmental hazard, which raises additional legal issues. State and federal government agencies such as the Environmental Protection Agency (EPA) and the Occupational Safety and Health Administration (OSHA) require that particular fluids be handled with particular precautions. For example, EPA regulations often dictate how a fluid may be disposed of properly, and OSHA regulations dictate that employees have a “right to know” what materials are in a facility.

According to an aspect of an exemplary embodiment of the present invention, disclosed herein is a color-coded system including various color-coded objects on the modules of the system. For example, color-coding may include a common color applied to a plurality of the following things corresponding to a particular fluid: (1) fluid storage tank or container, (2) fluid-dispensing knob, (3) fluid dispensing handle, (5) fluid dispensing hose, (6) fluid dispensing trigger, (7) label (e.g., on a bulk storage container, fluid storage container, or intermediate container, near a fluid dispensing tap or fluid dispensing hose, near a point of application), (5) label holder, (8) container collar, (9) container lid, (10) inlet or point of application (e.g. on a machine). This color-coding feature is useful for reducing confusion and mistakes.

According to another aspect of an exemplary embodiment of the present invention, disclosed herein is a modular system having system modules that are designed to fit within a standard shipping rectangle, e.g. 46 inches wide by 46 inches deep by 88 inches tall. This feature allows system modules to be shipped substantially pre-assembled, thereby substantially reducing or eliminating the assembly required by the end-user. The modules may also be re-configured subsequent to initial assembly, with the reconfiguration being facilitated by the modular nature of the system and design of the modules as disclosed herein.

While the principal advantages and features of several embodiments of the invention have been discussed above, a greater understanding of the invention including a fuller description of its other advantages and features may be attained by referring to the drawings and the detailed description of the exemplary embodiment which follow.

### BRIEF DESCRIPTION OF THE DRAWINGS

FIG. 1(a) depicts a left perspective view of an exemplary lubrication work center.

FIG. 1(b) depicts a right perspective view of an exemplary lubrication work center.

FIG. 1(c) depicts a front view of an exemplary lubrication work center.

FIG. 1(d) depicts a back view of an exemplary lubrication work center.

FIG. 1(e) depicts a top view of an exemplary lubrication work center.

FIG. 1(f) depicts a bottom view of an exemplary lubrication work center.

FIG. 1(g) depicts a right perspective view of an exemplary lubrication work center.

FIG. 1(h) depicts an exemplary fluid storage, fluid dispensing, and equipment storage module.

FIG. 1(i) depicts an exemplary fluid storage and equipment storage module.

FIG. 1(i) depicts an exemplary fluid storage module.

FIG. 2(a) depicts a module enclosed in a shipping container.

FIG. 2(b) depicts a perspective view of an exemplary fluid storage module.

FIG. 2(c) depicts a right perspective view of an exemplary fluid storage module.

FIG. 2(d) depicts a side view of an exemplary fluid storage module.

FIG. 2(e) depicts a perspective view of an exemplary fluid storage module with a hose connected to a pump and a drum.

FIG. 2(f) depicts a front view of an exemplary fluid storage module.

FIG. 2(g) depicts a bottom portion of an exemplary fluid storage module.

FIG. 2(h) depicts a bottom portion of an exemplary fluid storage module.

FIG. 2(i) depicts a bottom portion of an exemplary fluid storage module.

FIG. 2(j) depicts a bottom portion of an exemplary fluid storage module.

FIG. 2(k) depicts a left side view of a bottom portion of an exemplary fluid storage module.

FIG. 2(l) depicts a left side view of a top portion of an exemplary fluid storage module.

FIG. 2(m) depicts a front view of an exemplary fluid storage module.

FIG. 2(n) depicts a front view of an exemplary fluid storage module.

FIG. 2(o) depicts a front view of on an exemplary fluid storage container on an exemplary fluid storage module.

FIG. 2(p) depicts a side view of an exemplary fluid storage container in an exemplary fluid storage module.

FIG. 2(q) depicts a bottom portion of an exemplary fluid storage module.

FIG. 2(r) depicts a bottom portion of an exemplary fluid storage module.

FIG. 3(a) depicts a perspective view of an exemplary fluid dispensing module.

FIG. 3(b) depicts a front view of a top portion of an exemplary fluid dispensing module.

FIG. 3(c) depicts a front view of a top portion of an exemplary fluid dispensing module.

FIG. 3(d) depicts a front view of a top portion of an exemplary fluid dispensing module.

FIG. 3(e) depicts a front view of a top portion of an exemplary fluid dispensing module.

FIG. 3(f) depicts a front view of a bottom portion of an exemplary fluid dispensing module.

FIG. 3(g) depicts a rear view of an exemplary fluid dispensing module.

FIG. 3(h) depicts a right perspective view of an exemplary fluid dispensing module and an exemplary fluid storage module.

FIG. 3(i) depicts a side view of an exemplary fluid dispensing module.

FIG. 4(a) depicts a perspective view of an exemplary equipment storage module.

FIG. 4(b) depicts a side view of an exemplary equipment storage module.

FIG. 4(c) depicts a front view of an exemplary equipment storage module.

FIG. 5(a) depicts an exemplary basic fluid storage and dispensing module.

FIG. 6(a) depicts an exemplary advanced fluid storage and dispensing module.

FIGS. 7(a) and 7(b) depict exemplary suction hose storage systems.

FIG. 8(a) depicts an exemplary connector for connecting spill pans between modules.

FIGS. 8(b) and 8(c) depict an exemplary static discharge reel.

### DETAILED DESCRIPTION OF THE EXEMPLARY EMBODIMENTS

### Definitions

As used herein, the term “forklift” means, broadly, any device used for lifting and/or moving objects, whether motorized or not, including, but not limited to, a forklift, pallet jack, pallet truck, pump truck, jigger, lift truck, high/low, or fork hoist.

As used herein, the term “connected” means, broadly, any type of connection between components, including a temporary or permanent connection, and including a direct or indirect connection (e.g. an indirect connection via one or more intermediate connections).

Lubrication Work Center

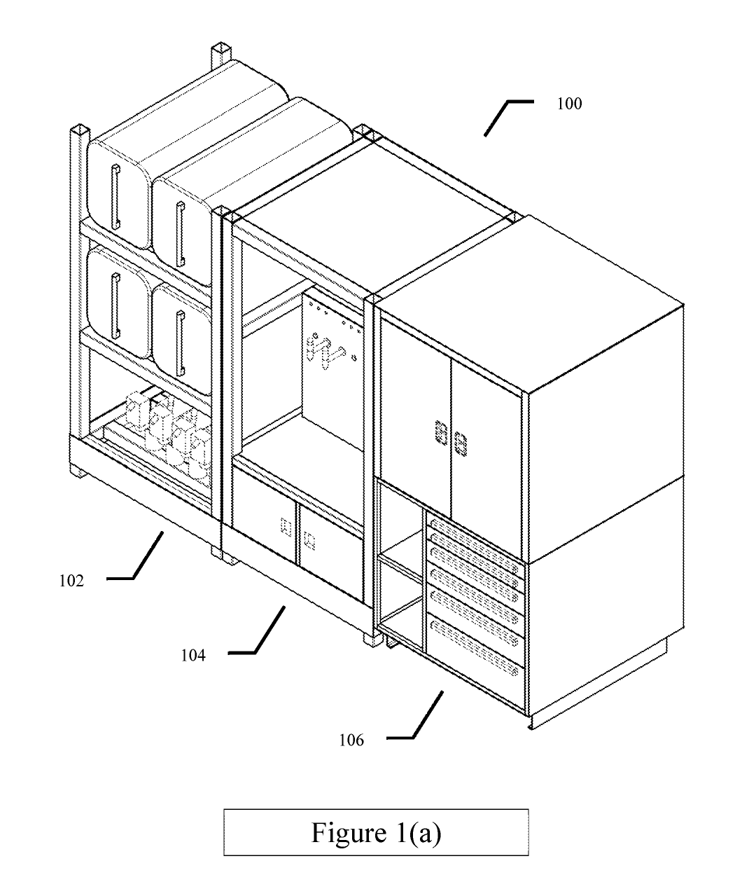

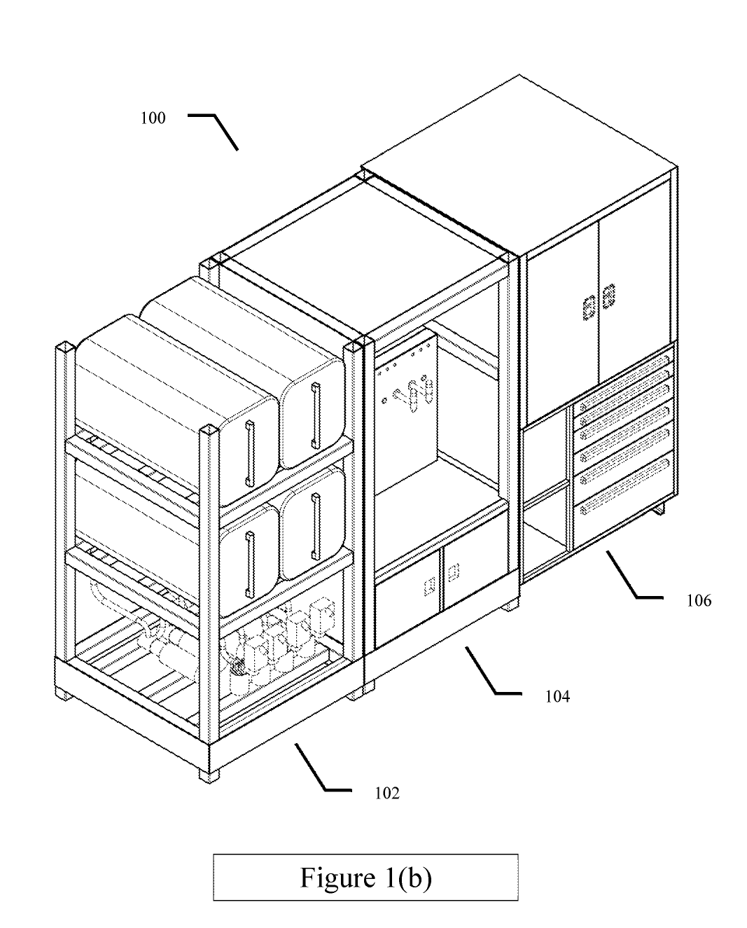

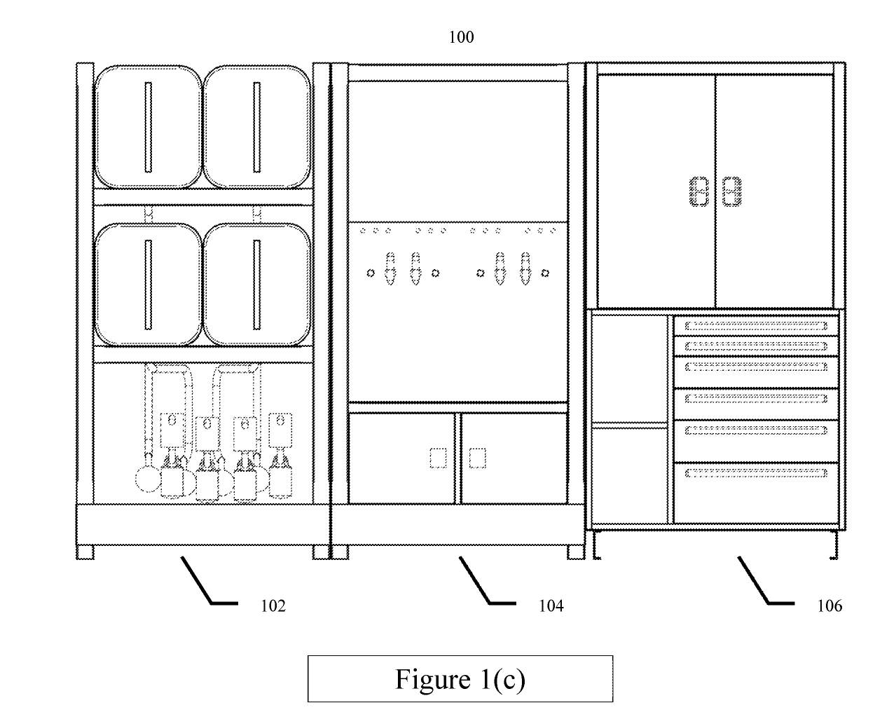

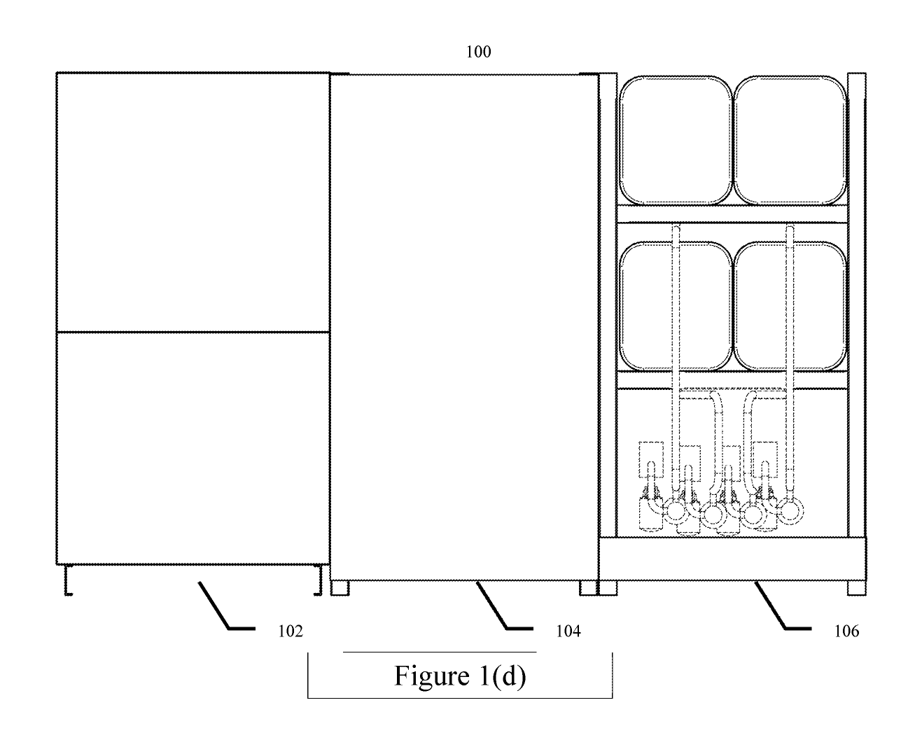

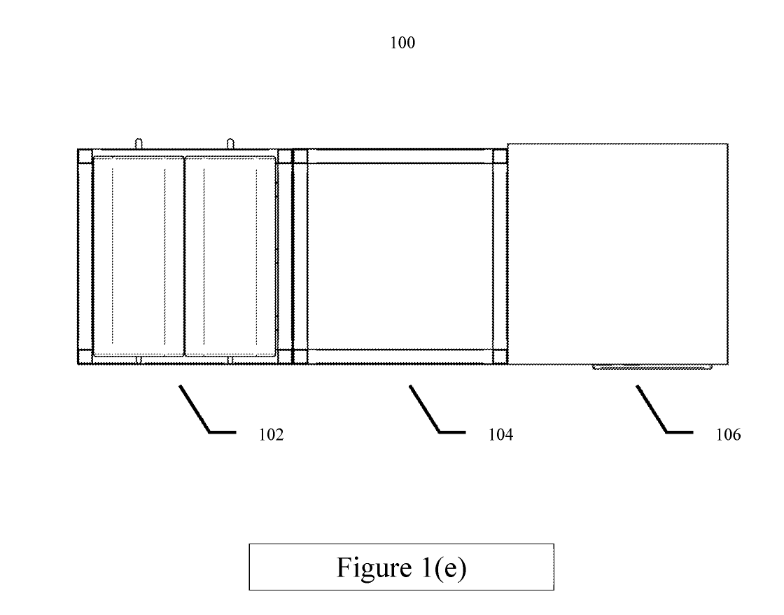

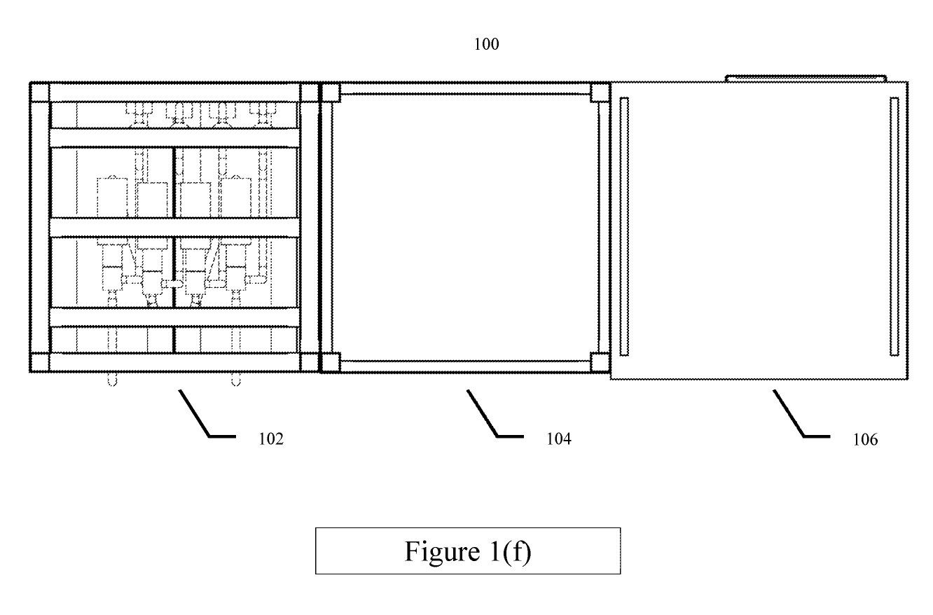

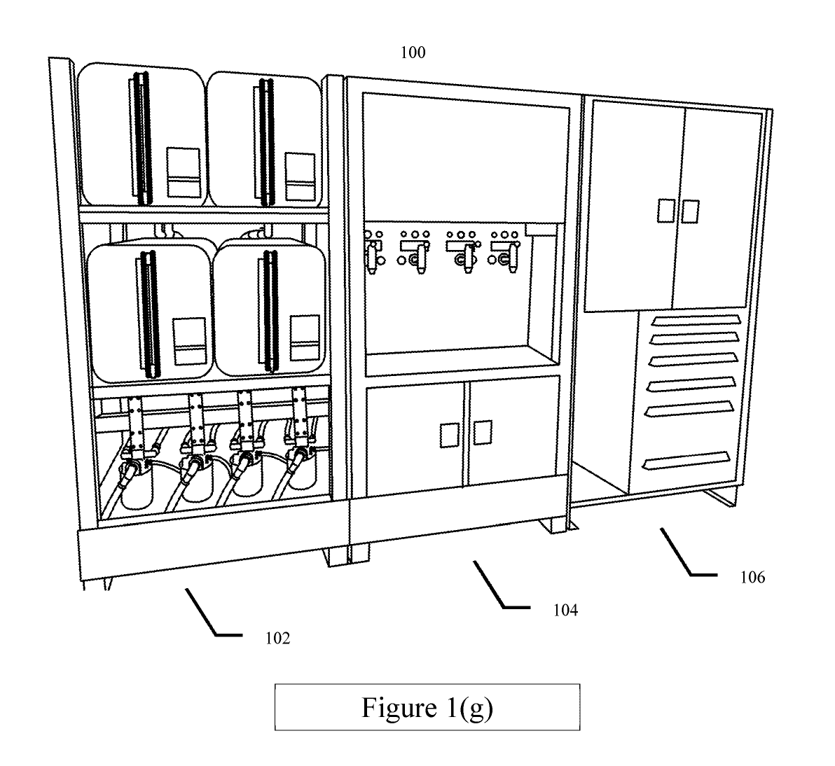

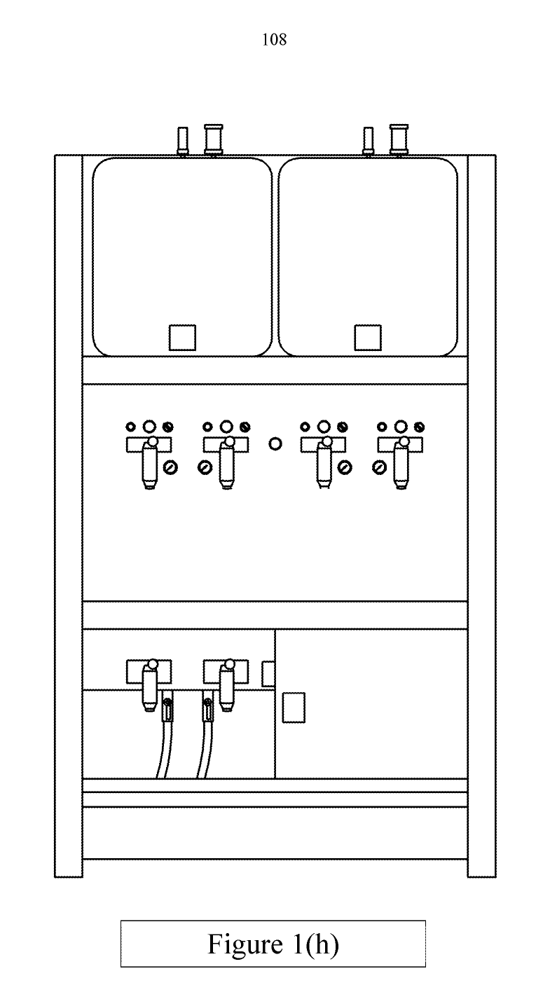

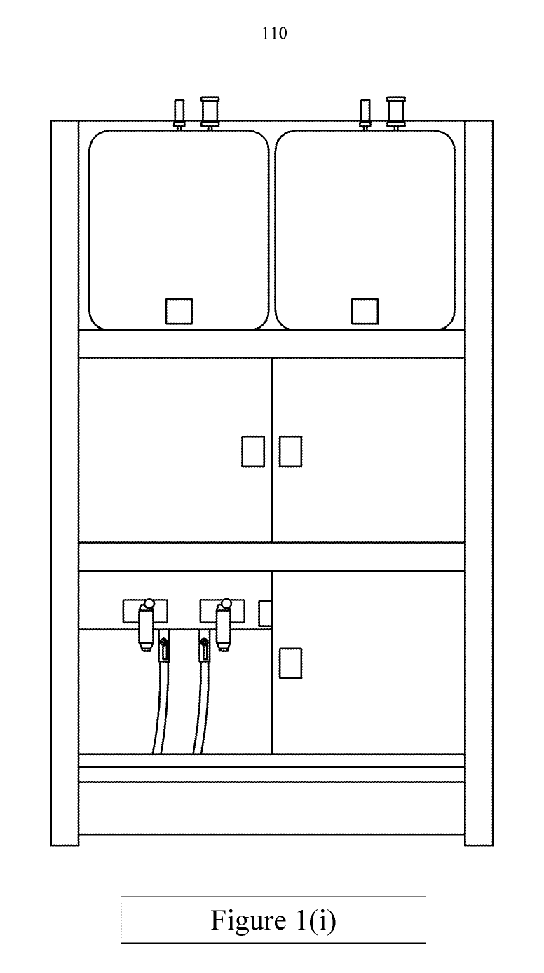

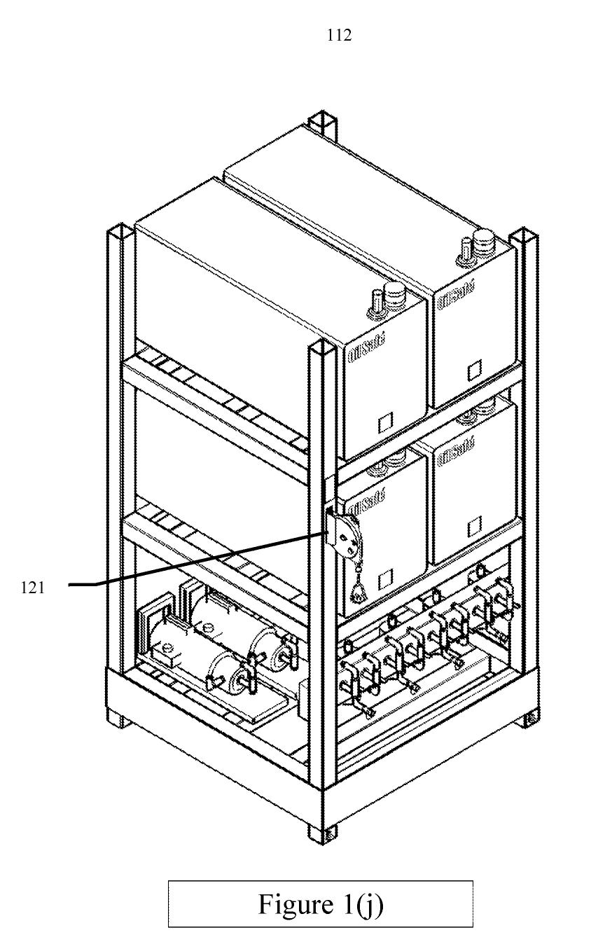

FIG. 1(a) depicts a left perspective view of an exemplary lubrication work center 100. Exemplary lubrication work center 100 comprises 3 stand-alone modules in a side-by-side arrangement. From left to right the modules of the exemplary lubrication work center 100 are: fluid storage module 102, fluid dispensing module 104, and equipment storage module 106. The embodiment of FIG. 1(a) is merely exemplary—a lubrication work center may comprise any combination of any number of modules, as required by the end-user. For example, a lubrication work center may comprise 2 fluid storage modules, 1 fluid dispensing module, and no equipment storage module.

As can be seen, each module is a self-contained module that stands freely without support of any other module. The weight on each module is evenly balanced such that it is stable and not prone to tipping. For example, lighter components (for example, empty fluid storage containers) are located near the top of the module, while heavy components (for example, pumps, hose reels, and hoses) are located near the base of the module, thereby lowering the center of gravity for the module. Thus, each module can be shipped independently in a single shipping container as discussed below.

Furthermore, the composition and arrangement of a lubrication work center may be easily modified at any time by simply adding, removing, and/or re-arranging the modules within the work center 100.

According to an exemplary embodiment, a fluid storage module and a fluid dispensing module are designed to be used together. This may involve interconnecting the storage container(s) of the fluid storage module with the dispensing component(s) of the fluid storage module via one or more hoses or the like. For example, a user may connect hoses to the pumps between the fluid storage module and to the inputs on the fluid dispensing module, thereby allowing the fluid stored in the fluid storage module to be dispensed by the fluid dispensing module via the pumps.

FIGS. 1(b)-1(g) depict various additional views of the exemplary lubrication work center 100.

It should be understood that the various module types and components described herein are not mutually exclusive. Each module is customizable and the component parts are interchangeable. For example, a fluid storage module may also comprise fluid dispensing components such as fluid dispensing taps and hoses, and/or equipment storage components such as shelves, cabinets and drawers. A fluid dispensing module may also comprise fluid storage components such as fluid storage containers and pumps, and/or equipment storage components such as shelves, cabinets and drawers. An equipment storage module may comprise fluid storage components such as fluid storage containers and pumps, and/or fluid dispensing components such as fluid dispensing taps and hoses. FIG. 1(h) depicts an exemplary fluid storage, fluid dispensing, and equipment storage module 108. FIG. 1(i) depicts an exemplary fluid storage and equipment storage module 110. A variety of exemplary system configurations are shown in Appendix A.

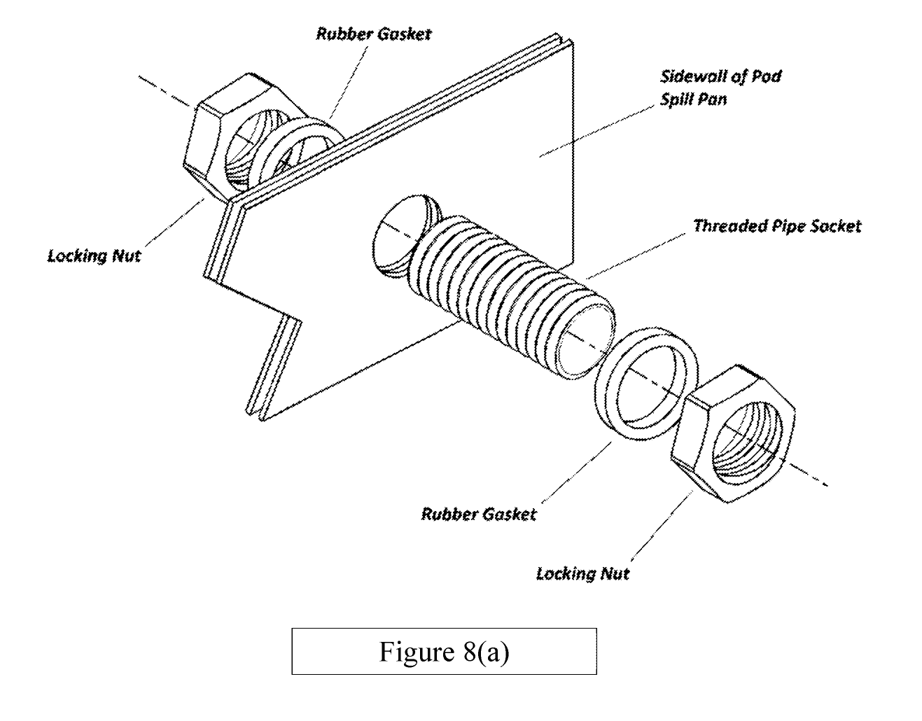

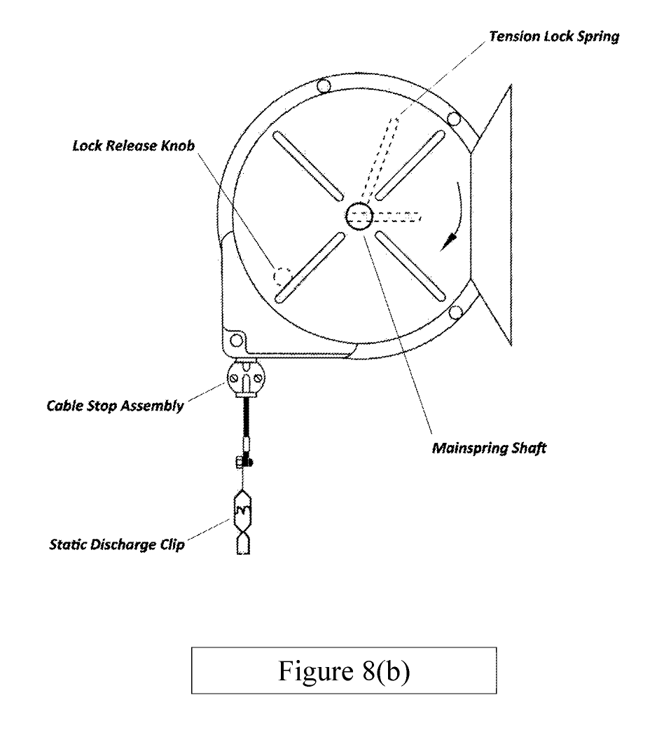

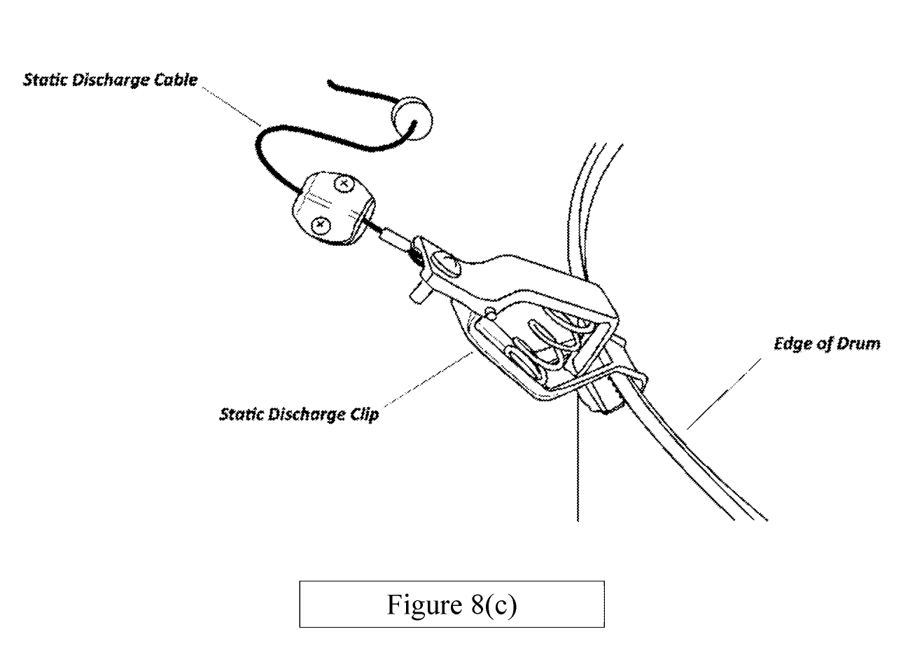

A variety of optional accessories are available for attachment to the modules. For example, FIG. 1(j) depicts a fluid storage module 112 comprising a retractable static discharge grounding reel 121, shown in more detail in FIGS. 8(b)-8(c).

Fluid Storage Module

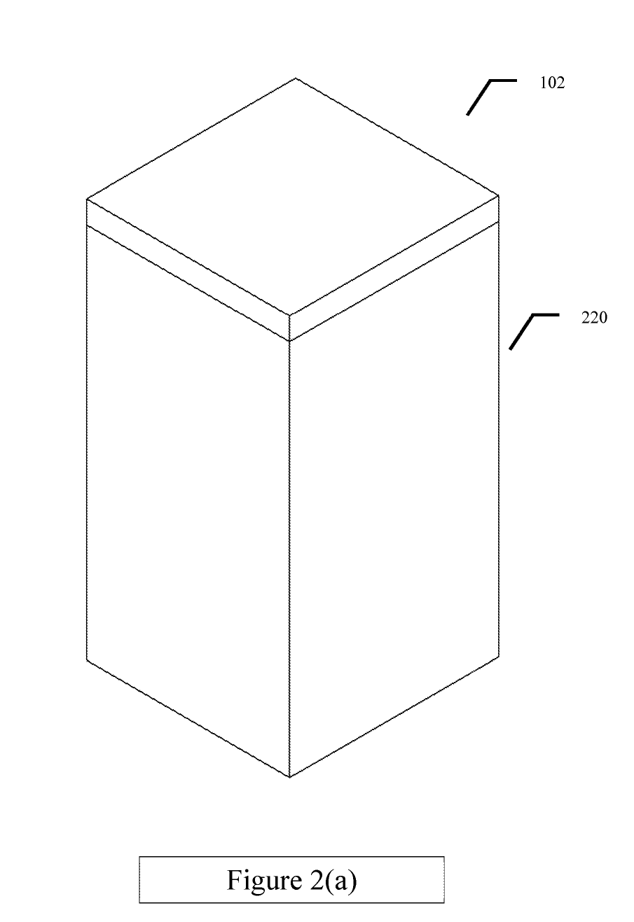

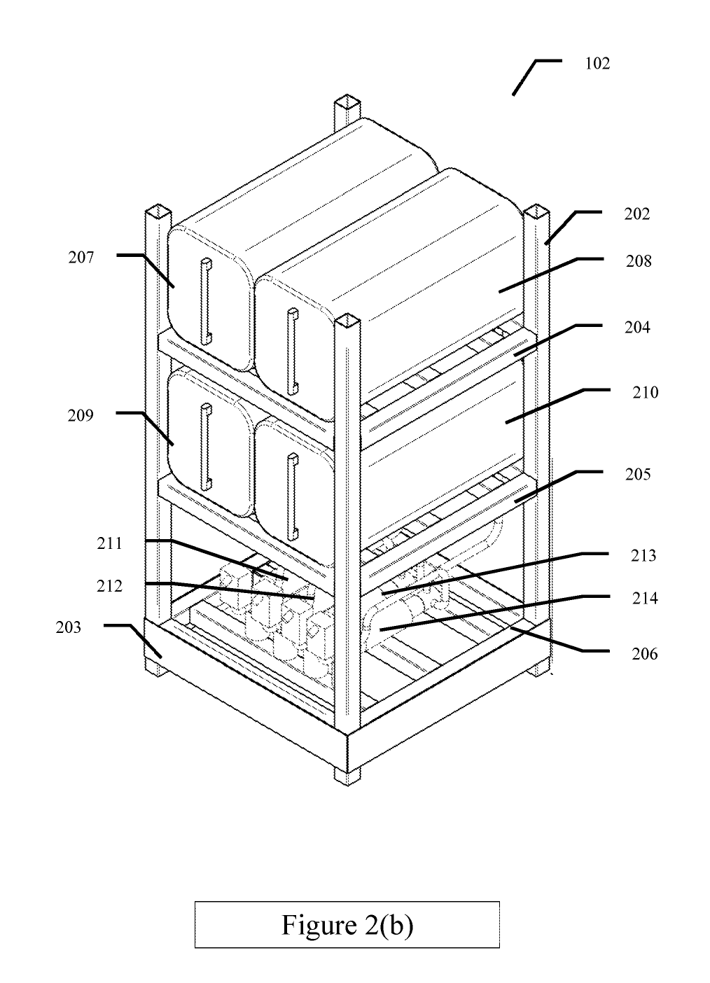

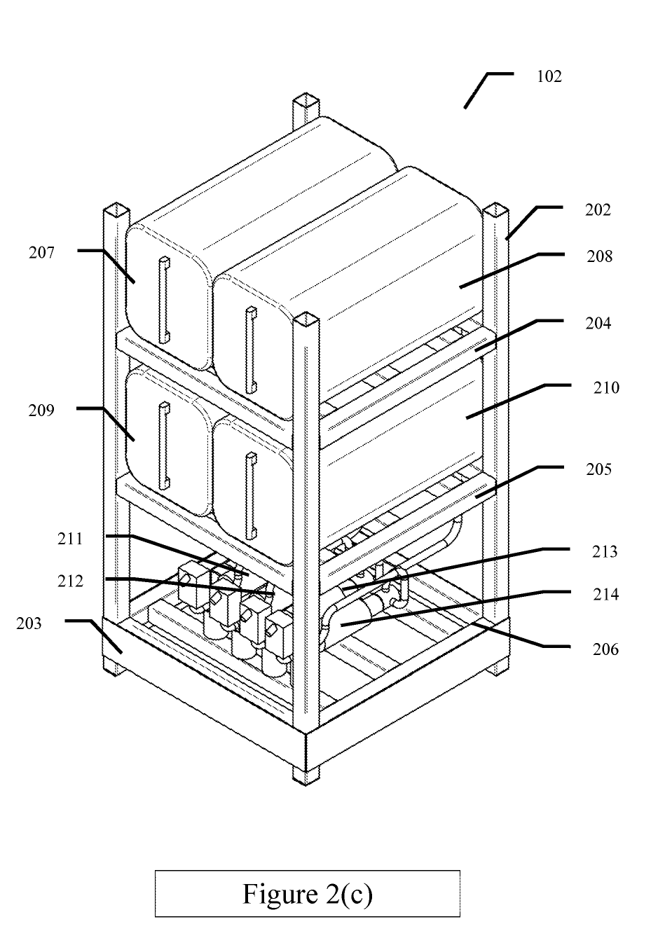

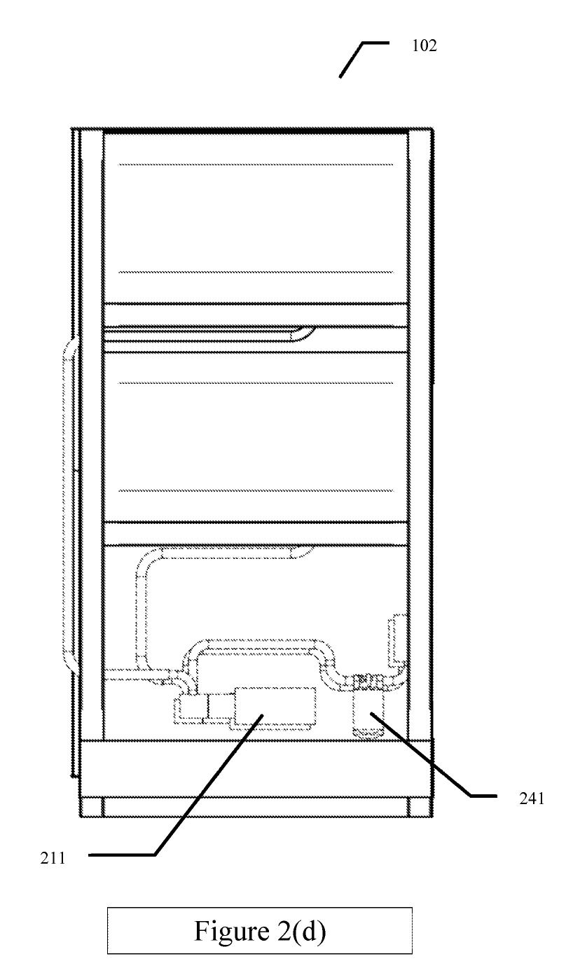

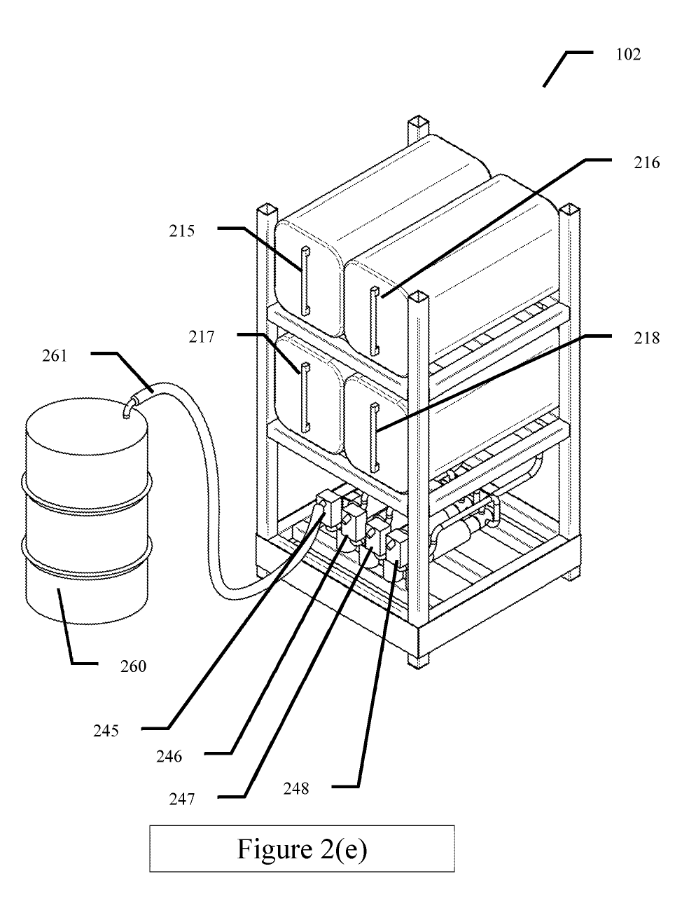

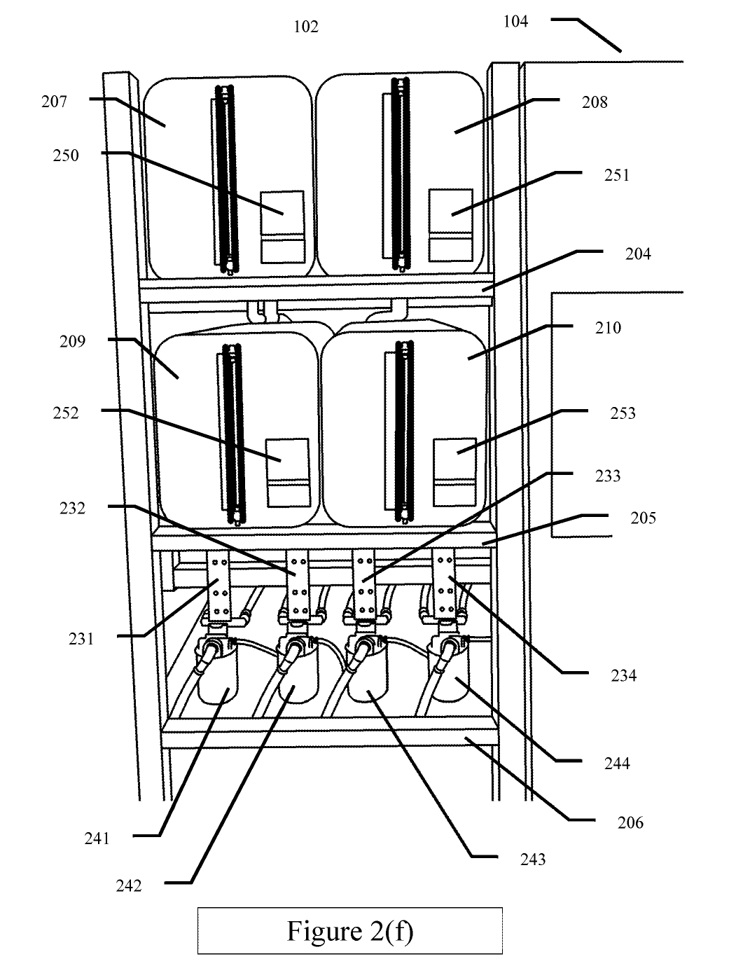

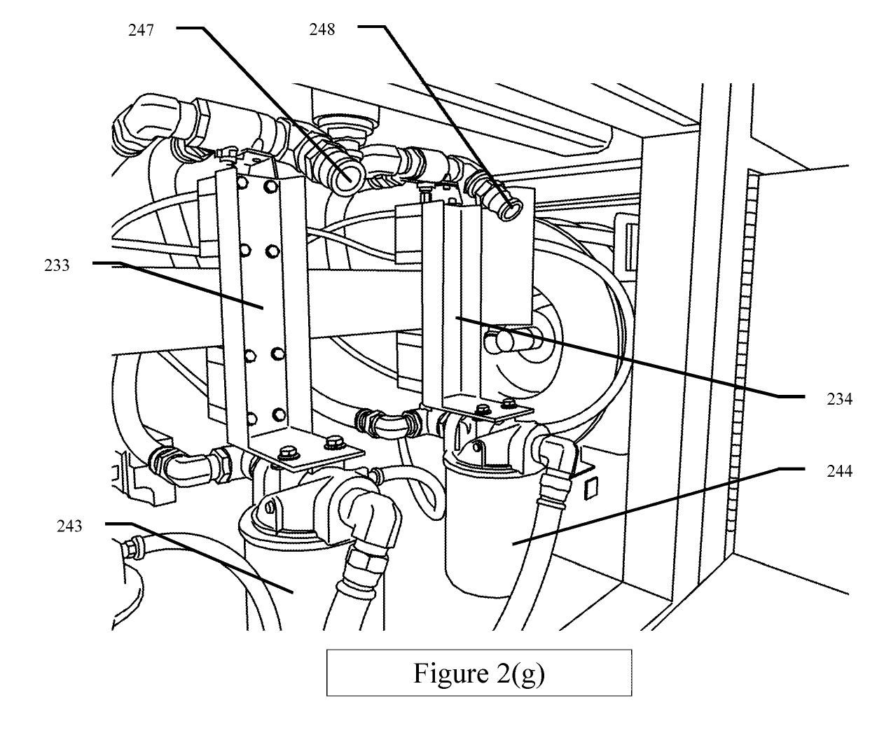

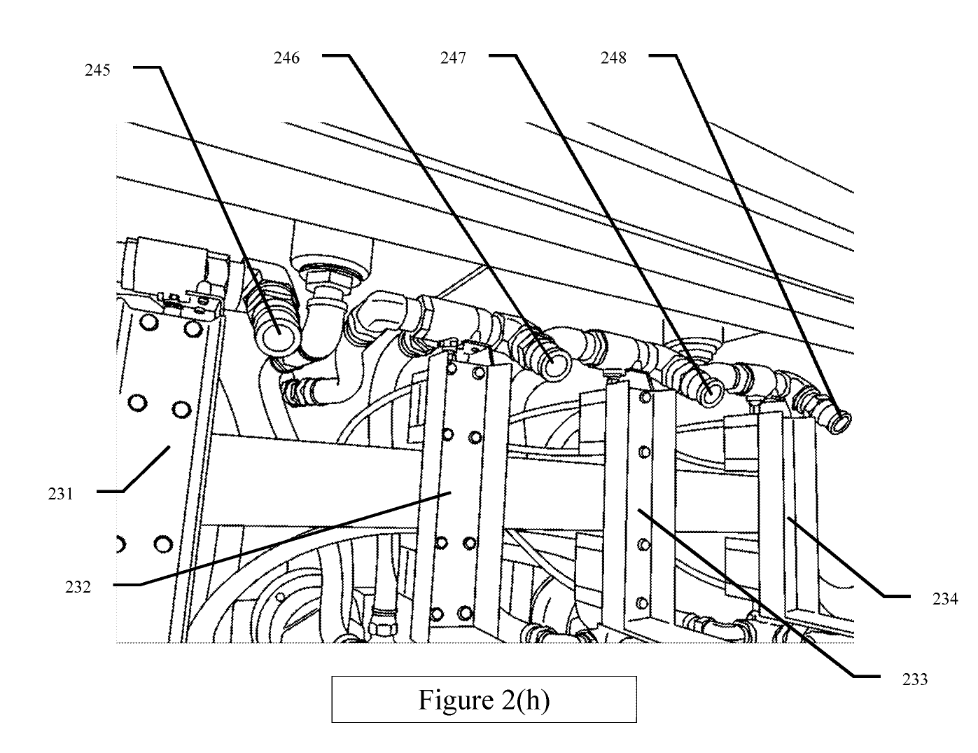

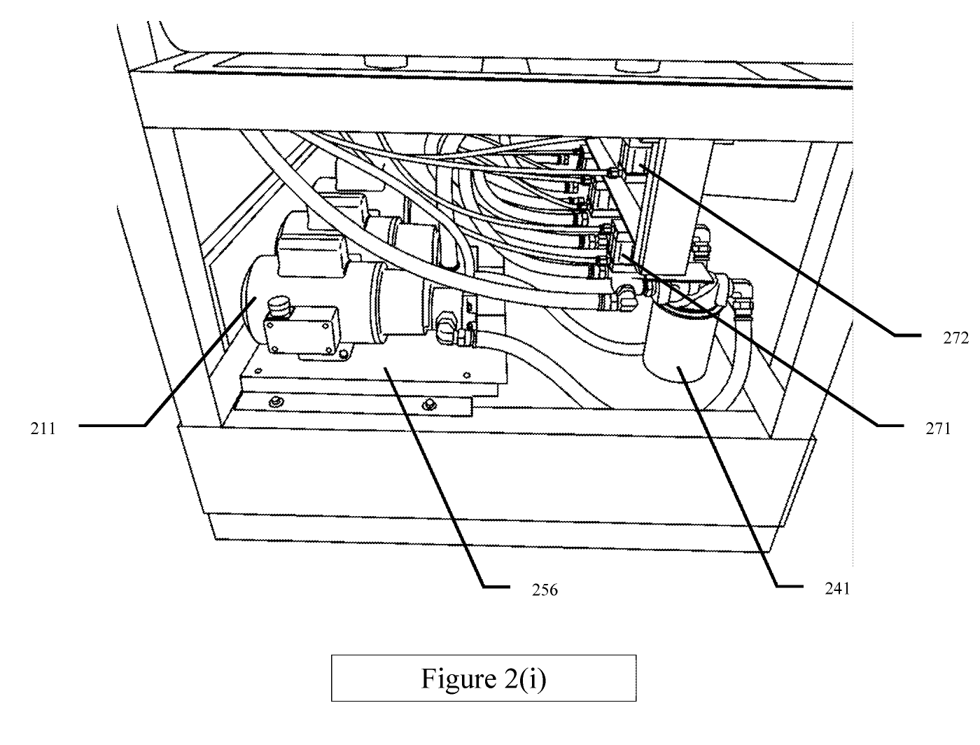

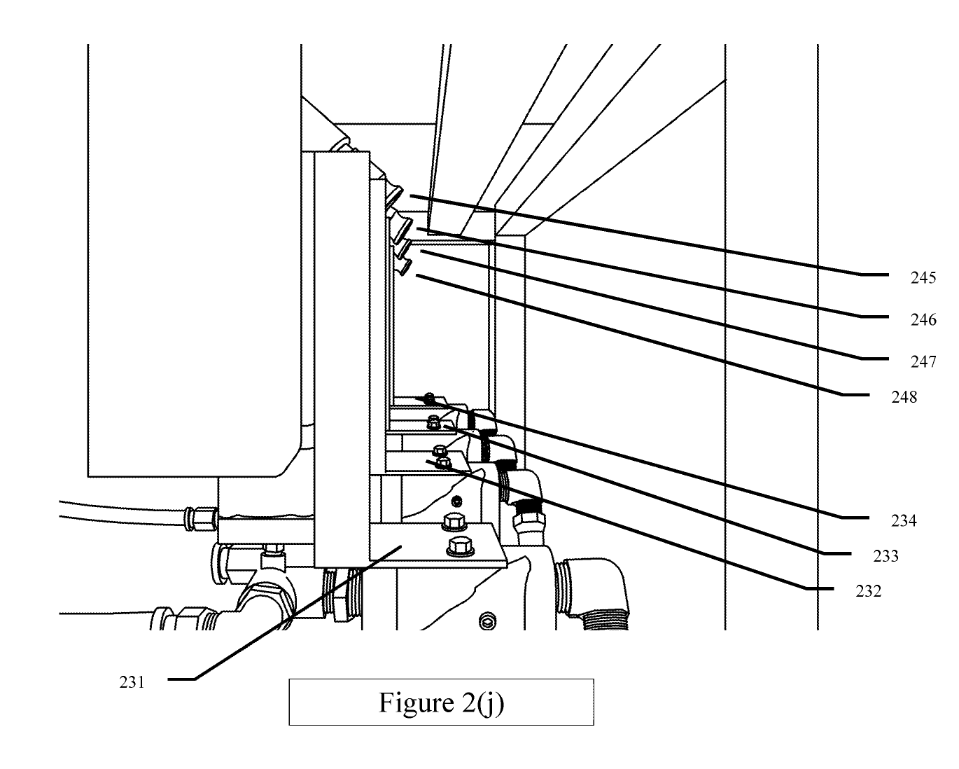

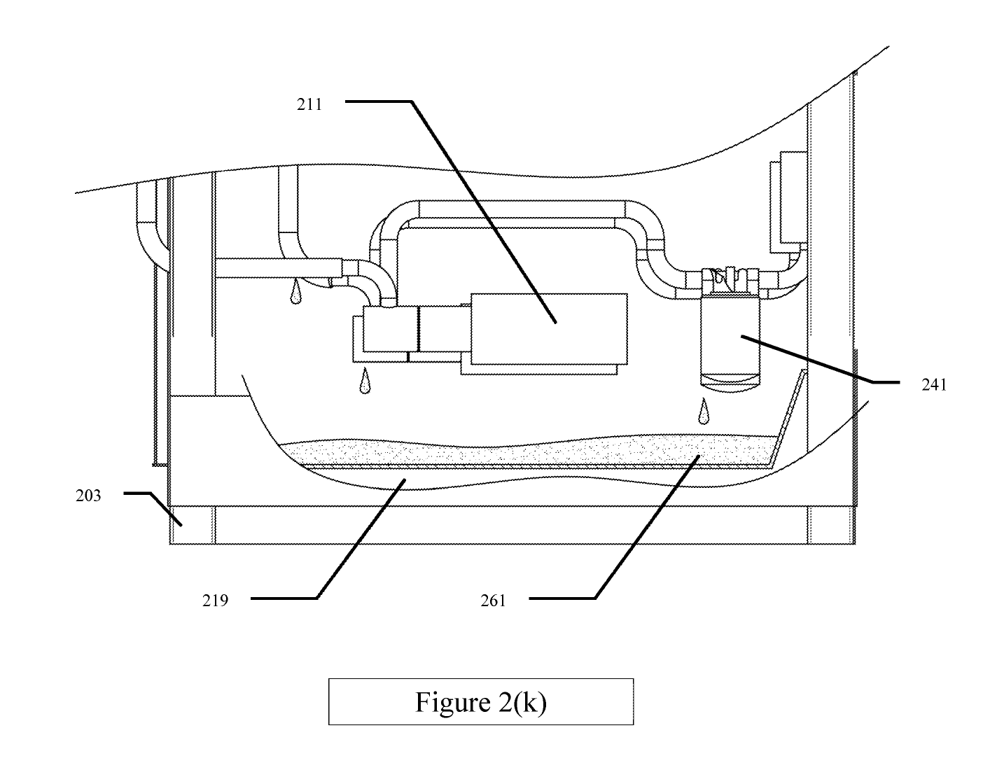

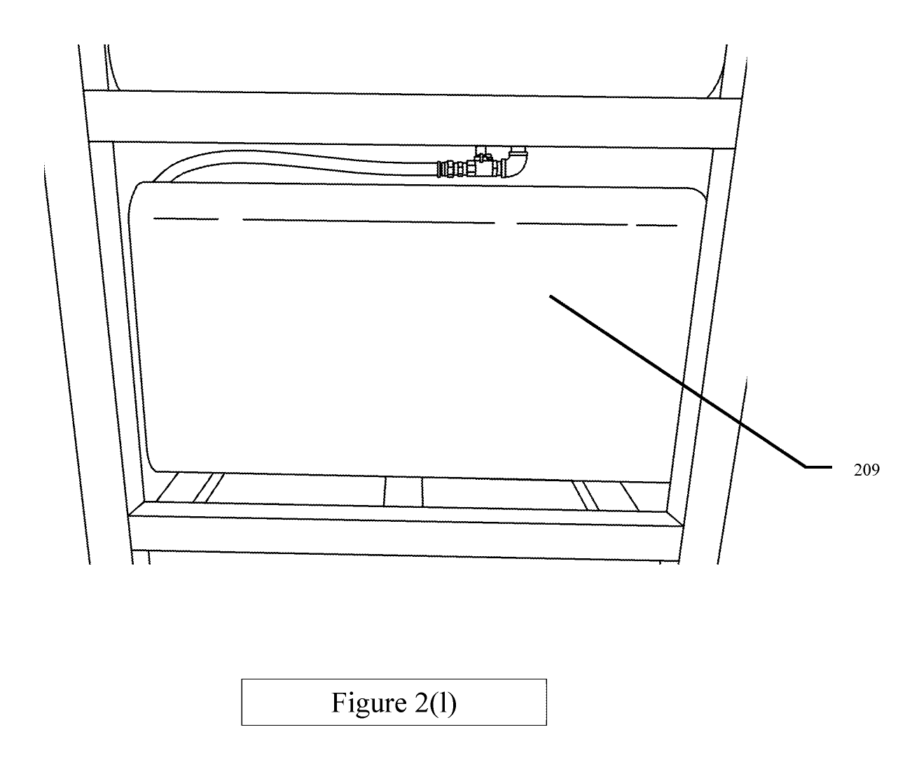

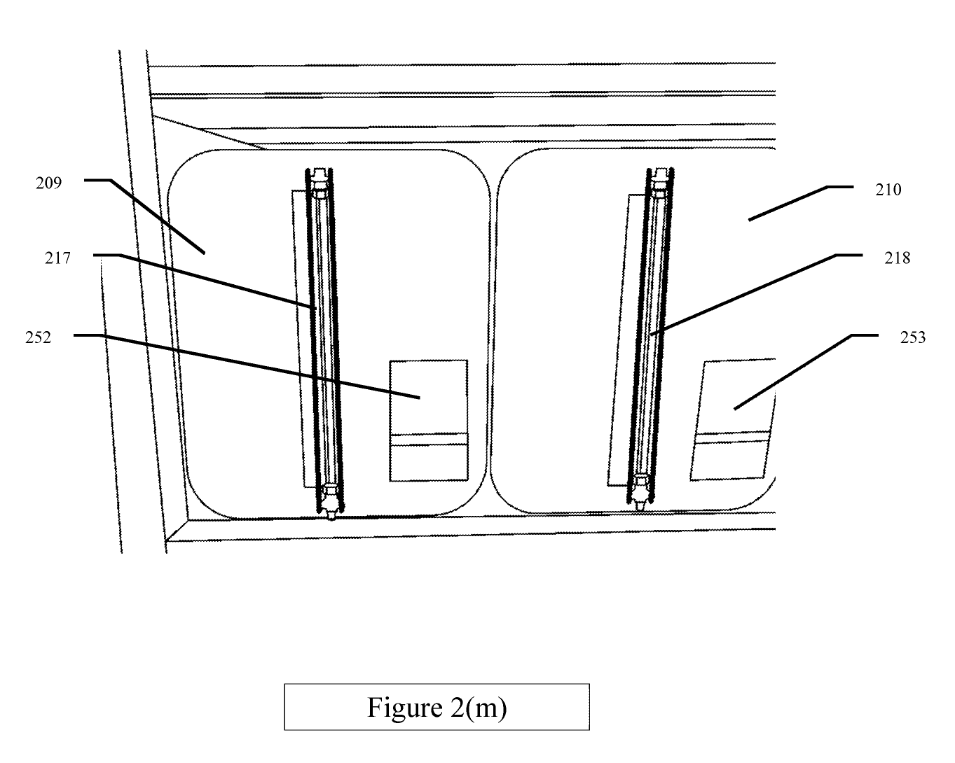

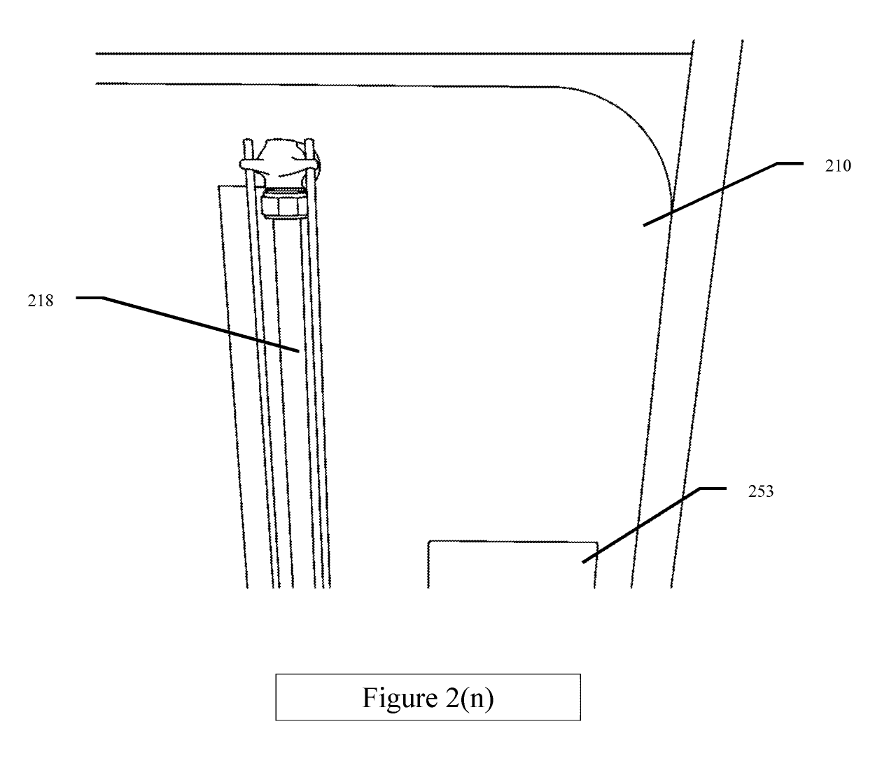

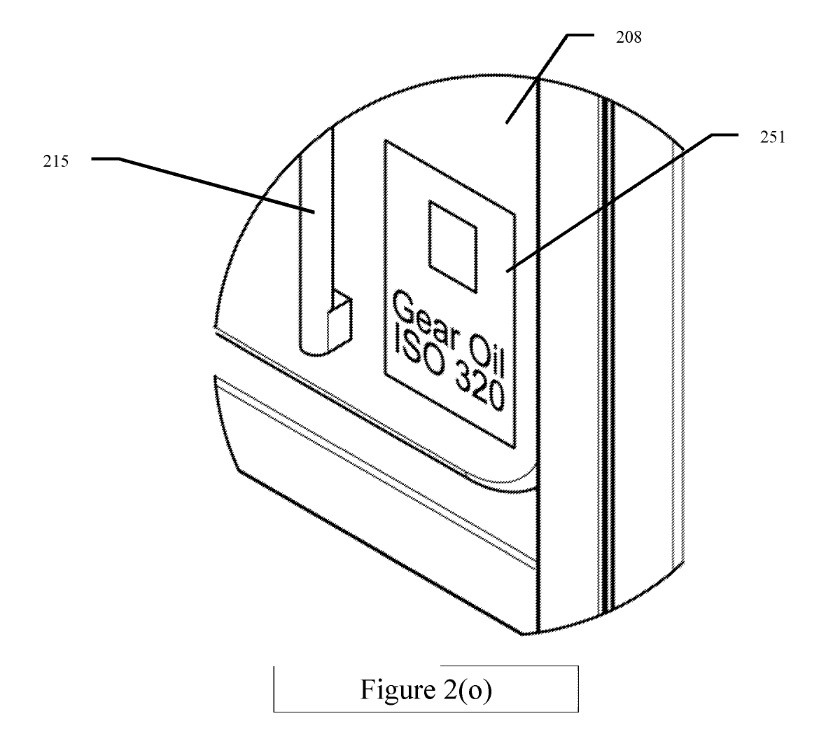

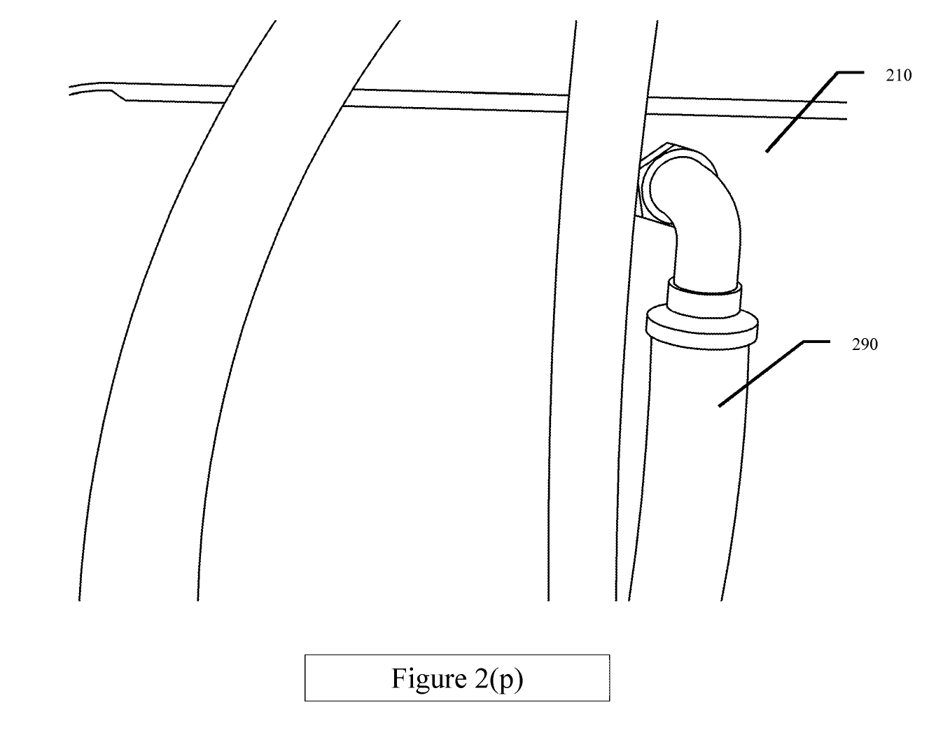

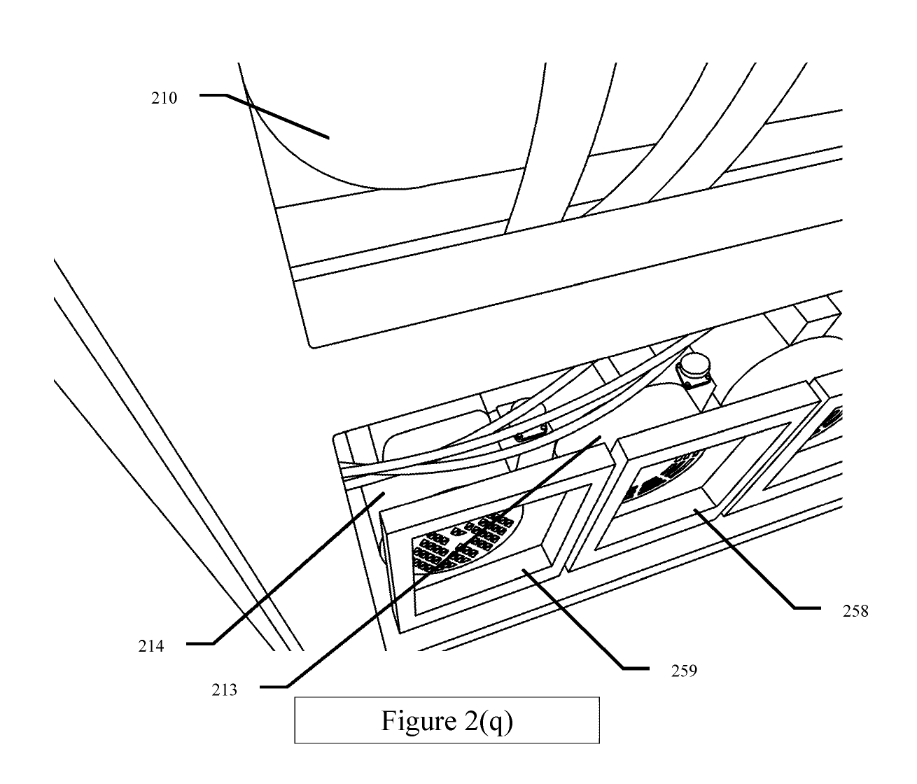

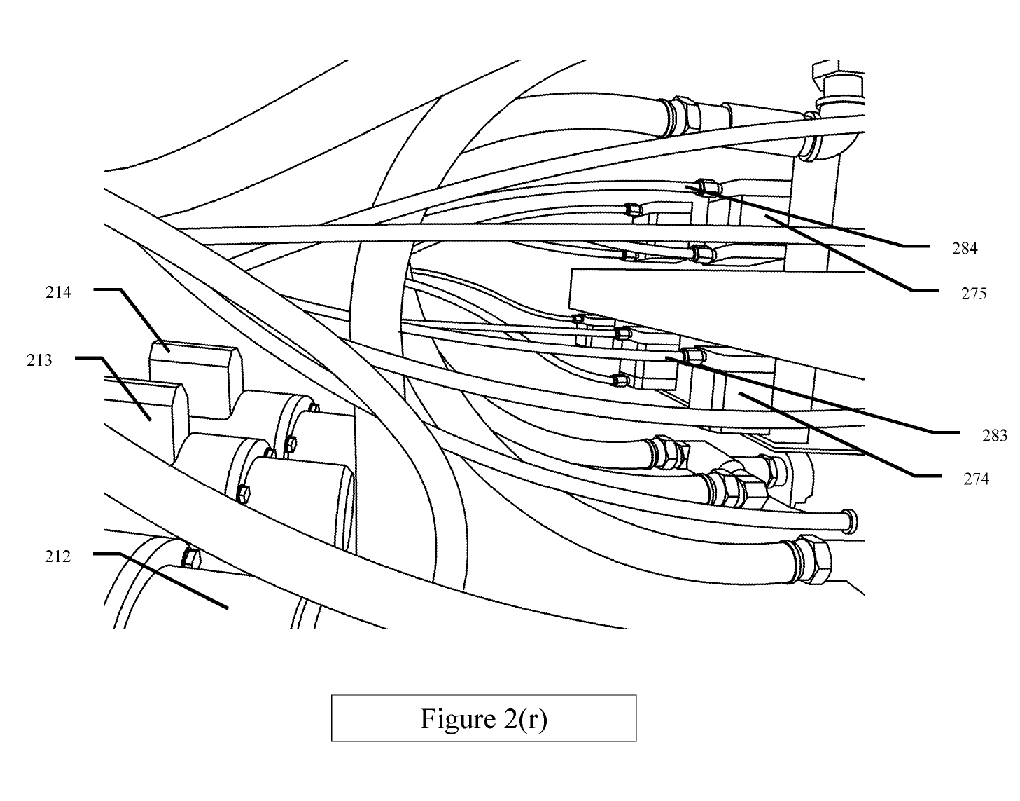

As noted above, one of the exemplary module types that can be employed in the lubrication work center 100 is a fluid storage module 102. FIG. 2(a) depicts a fluid storage module 102 enclosed in a shipping container 220. In an exemplary embodiment, the fluid storage module 102 can be sized to fit within a single shipping container when that fluid storage module has already been assembled for use (except for any hose interconnections with a fluid dispensing module 104 that may be needed).

While FIG. 2(a) has been described herein in the context of a fluid storage module 102, it should be understood that any of the other module types (e.g., exemplary fluid dispensing module 104 or exemplary equipment storage module 106) for use in the lubrication work center 100 could also be sized to fit within a shipping container 220 when already assembled.

A standard shipping container typically measures 46 inches wide by 46 inches deep by 88 inches tall. To fit within a standard shipping container, each module preferably has slightly smaller dimensions. For example, each module could be 45 inches wide by 45 inches deep by 87 inches tall. It will be apparent that embodiments of the present invention could be configured for any size shipping container (e.g. non-standard shipping containers). Each module may be shipped to an end-user substantially pre-assembled, as described in detail below. Each module is preferably sturdy enough to endure shipping without significant damage. Each module can have a frame made from a metal such as steel, and the frame may comprise a 3″ by 3″ steel bar. The frame may be hollow or solid. In an exemplary embodiment, the frame is hollow and can be used to channel fluid to a spill pan, or as a conduit for, e.g., electrical cables and/or air vent tubes.

FIG. 2(b) depicts a perspective view of an exemplary fluid storage module 102 having a frame 202, fluid storage containers 207, 208, 209, and 210, and pumps 2011, 212, 213, and 214.

Frame 202 comprises a bottom portion 203 configured to receive the forks of a forklift. The exemplary bottom portion 203 is configured to receive forks from any of its four sides. In an exemplary embodiment, bottom portion 203 may also comprise a fluid spill pan 219, as shown in FIG. 2(k).

In an exemplary embodiment, a fluid storage module 102 is configured to be shipped substantially pre-assembled. For example, fluid storage containers 207 and 208 may be securely connected to a top shelf portion of the frame 204, fluid storage containers 209 and 210 may be securely connected to a middle shelf portion of the frame 205, and pumps 211-214 may be securely connected to a bottom shelf portion of the frame 206. The secure attachment can be accomplished by any known means, including releasable means such as bolts for bolting the containers and pumps to the frame. In an exemplary embodiment, storage containers 207-210 are connected to frame 202 such that the weight of the storage containers is evenly balanced. In an exemplary embodiment, pumps, which are relatively heavy, are connected to a lower portion of the frame to provide a low center of gravity for the module. Thus, the fluid storage module may be shipped substantially pre-assembled, thereby allowing a customer or user to avoid the time, delay, and expense of assembling the module 102 from its individual components. These features also facilitate subsequent system reconfiguration because each module is easily moved using a forklift. These features also provide resistance to tipping or damage in subsequent use, such as during an earthquake, tornado, or accidental impact.

In an exemplary embodiment, each fluid storage container (e.g. fluid storage containers 207-210) can be painted a different color according to a fluid identification convention as described below.

In an exemplary embodiment, each pump (e.g. pumps 211-214) is connected to exactly one fluid storage container (e.g. containers 207-210) to prevent mixing of different fluids. For example, in the exemplary embodiment of FIG. 2(b) pump fluid storage container 207 is connected to pump 211, fluid storage container 208 is connected to pump 212, etc. However, this need not be the case, and a single pump could be connected to multiple containers (e.g. with a container selection switch used to intermediate which of the storage containers is to be connected to an input or output via the pump).

Other exemplary embodiments may provide different numbers and sizes of fluid storage containers and pumps. For example, an exemplary fluid storage module could comprise 4 fluid storage containers on the top shelf portion 204 (each container being half the width of the containers shown in FIG. 2(b)), two half-size containers on the middle shelf 205, and two additional pumps on the middle shelf 205.

Exemplary fluid storage container options for installation on one fluid storage module include, without limitation:

1 240 gallon tank;

2 120 gallon tanks;

4 65 gallon tanks; and

8 30 gallon tanks.

FIG. 2(c) depicts a right perspective view of an exemplary fluid storage module 102.

FIG. 2(d) depicts a left side view of an exemplary fluid storage module 102. A leftmost pump 211 and leftmost filter 241 are visible.

FIG. 2(e) depicts a right perspective view of an exemplary fluid storage module 102. Also shown is a standard bulk storage container 260, such as a 55 gallon oil drum. In an exemplary embodiment, each fluid storage container 207-210 comprises a site level gauge 215-218 on the front of the container. However, it would also be possible to utilize other types of level gauges, such as a level gauge installed on top of the container. Each pump 211-214 is connected to a fluid inlet 245-248 for pumping fluid from an external source (such as bulk storage container 260) and into the fluid storage container 207-210 corresponding to that pump.

In an exemplary embodiment, each pump is connected to a plurality of user-selectable pump path. For example, each pump may be associated with 3 selectable pump paths. In an exemplary embodiment, the 3 user-selectable paths for each pump are as follows:

(1) intake—In this path, the pump moves fluid from the intake valve to the corresponding fluid storage container;

(2) recirculation—In this path, the pump moves fluid from the fluid storage container, through the filter, and back into the fluid storage container; and

(3) dispensing—In this path, the pump moves fluid from a fluid storage container to the corresponding fluid dispensing taps and/or fluid dispensing hoses for dispensing. In an exemplary embodiment, each pump is associated with a plurality of divertor valves which can be actuated to select a pump path. Divertor valves may be operated manually (e.g. by a lever) or operated automatically (e.g. pneumatically actuated in response to a remote button press).

FIG. 2(f) depicts a front view of exemplary fluid storage module 102 next to exemplary fluid dispensing module 104. Fluid storage containers 207-208 are mounted to top shelf 204, and fluid storage containers 209-210 are mounted to middle shelf 205. Each storage container has an affixed container label 250-253. Filters 241-244 can be seen near bottom shelf 206. Each filter is mounted to the frame by a separate, removable, steel filter manifold 231-234. For example, bolts may be used to mount each filter to each manifold, and each manifold to the frame. This allows the user to remove an entire filter assembly from the frame. Additional filter related accessories may be mounted to the filter manifold, such as differential pressure gauges that indicate when a filter needs to be replaced.

FIG. 2(g) depicts a bottom portion of an exemplary fluid storage module. Fluid inlets 247 and 248 can be seen above filters 243 and 244. In an exemplary embodiment, each filter is in the intake path between the fluid inlet and the corresponding fluid storage container. Thus, as fluid is pumped into a fluid storage container, the fluid passes through the corresponding filter before entering the fluid storage container.

FIG. 2(h) depicts a bottom portion of an exemplary fluid storage module, including fluid inlets 245-248 and filter manifolds 231-233.

FIG. 2(i) depicts a left side view of a bottom portion of an exemplary fluid storage module 102 having 4 pumps and 4 filters (only leftmost pump 211 and leftmost filter 241 are clearly visible). In an exemplary embodiment, each pump is connected to one fluid filter. The type of filter may depend on the type of fluid meant for use with the corresponding pump and corresponding fluid storage container. Pump 211 is mounted on pump caddy 256, as described in detail below.

FIG. 2(j) depicts a left side view of a bottom portion of an exemplary fluid storage module 102, including exemplary filter manifolds 231-233.

FIG. 2(k) depicts a left side view of a bottom portion of an exemplary fluid storage module 102 comprising an spill pan 219 integrated within bottom portion 203 for catching spilled fluid 261 from above.

FIG. 2(l) depicts a left side view of a top portion of an exemplary fluid storage module including fluid storage container 209.

FIG. 2(m) depicts a front view of an exemplary fluid storage module including fluid storage containers 209 and 210.

FIG. 2(n) depicts a front view of an exemplary fluid storage module including fluid storage container 210.

FIG. 2(o) depicts a close-up view of an exemplary fluid storage container 208 having an affixed container label 250. Container label 250 can be colored green and include an image of a square at the top. In an exemplary embodiment, each container on the fluid storage module (e.g. containers 207-210) has an affixed container label having a color and shape defined by a fluid identification convention as described below.

FIG. 2(p) depicts a rear view of an exemplary fluid storage container 210 in an exemplary fluid storage module 102. Bypass hose 290 connects is the discharge end of the pump pressure bypass return line. This is a safety feature that, in the event of a pump overpressure event, allows the pump to release excess pressure into the storage container 210 via the bypass hose. Bypass hose 290 is part of the recirculation path from the pump.

FIG. 2(q) depicts a rear view of a bottom portion of an exemplary fluid storage module 102, having exemplary pump caddies 259 and 258. In an exemplary embodiment, each pump (e.g. 211-214) is mounted on a slideable pump caddy (e.g. pump caddy 256-259). In another exemplary embodiment, each pump (e.g. 211-214) and filter (e.g. 241-244) are both mounted to a slideable pump caddy. Each pump caddy rests on slider rails and is releasably fastened in position, e.g., using bolts. Each slideable pump caddy allows a user to release and slide the pump caddy, including the pump and filter mounted thereon, completely out of the fluid storage module from the rear, for more complete access. In an exemplary embodiment, each pump caddy comprises a caddy label 264. In an exemplary embodiment, the caddy label 264 comprises a color and shape according to the fluid identification convention for the system.

FIG. 2(r) depicts a bottom portion of an exemplary fluid storage module. In this exemplary embodiment, the fluid storage module comprises 8 pneumatically operated divertor valves 271-279, with 2 divertor valves corresponding to each pump. Operation of the divertor valves switches the pump path between the 3 user-selectable pump paths (intake, recirculation, dispensing). For example, pump 212 is connected to divertor valves 274 and 275. Divertor valves 274-275 are pneumatically actuated by pneumatic tubes 283-284, respectively.

In an exemplary embodiment, a fluid identification convention is enforced throughout a facility, including on all modules, e.g. fluid storage module and fluid dispensing module, as described in detail below. A fluid identification convention defines a correspondence between a particular type of fluid and identifying features such as color, shape, reference number, etc. A fluid identification convention is useful for reducing confusion and mistake. An exemplary fluid identification convention is shown in Table 1.

TABLE 1
Exemplary Fluid Identification Convention

| Fluid | Color | Shape |
|---|---|---|
| Engine Oil SAE 5W-30 | Yellow | Circle |
| Hydraulic Oil ISO 68 | Red | Star |
| Compressor Oil ISO 46 | Purple | Triangle |
| Gear Oil ISO 320 | Green | Square |

Examples of systems and methods that can be used to control and implement a labeling and fluid identification convention for a lubrication work center are described in the following published patent applications: U.S. patent application Ser. No. 11/801,821 filed May 12, 2007, entitled “Supply Chain Label System”, and published as U.S. Pat. App. Pub. 2008-0276513, U.S. patent application Ser. No. 12/332,342 filed Dec. 11, 2008, entitled “Fitting Cover”, and published as U.S. Pat. App. Pub. 2010-0147629, U.S. patent application Ser. No. 12/396,444 filed Mar. 2, 2009, entitled “Label Identification And Management System For Fluids”, U and published as U.S. Pat. App. Pub. 2009-0281924, and U.S. patent application Ser. No. 12/469,624 filed May 20, 2009, entitled “Manual Pump For Dispensing Lubricants”, U. and published as U.S. Pat. App. Pub. 2009-0291005, the entire disclosures of each of which are incorporated herein by reference.

Fluid Dispensing Module

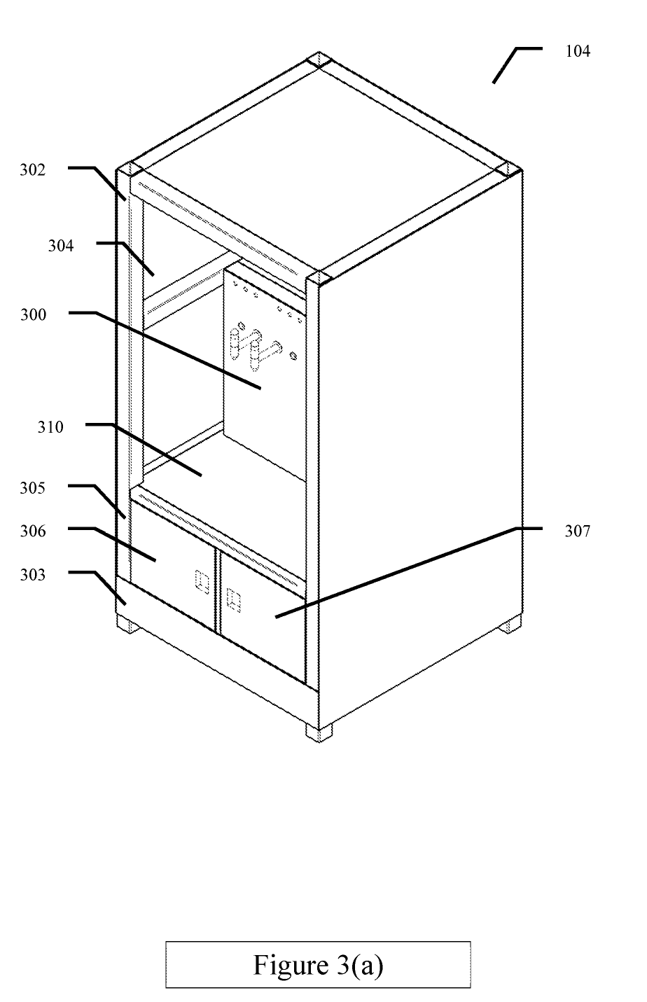

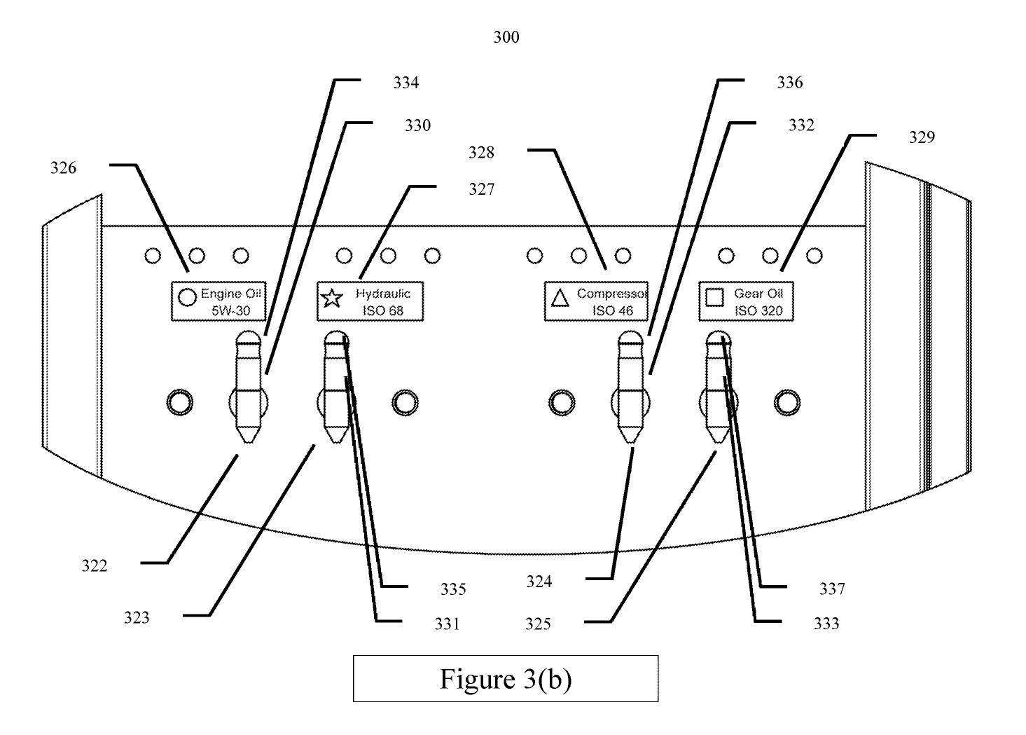

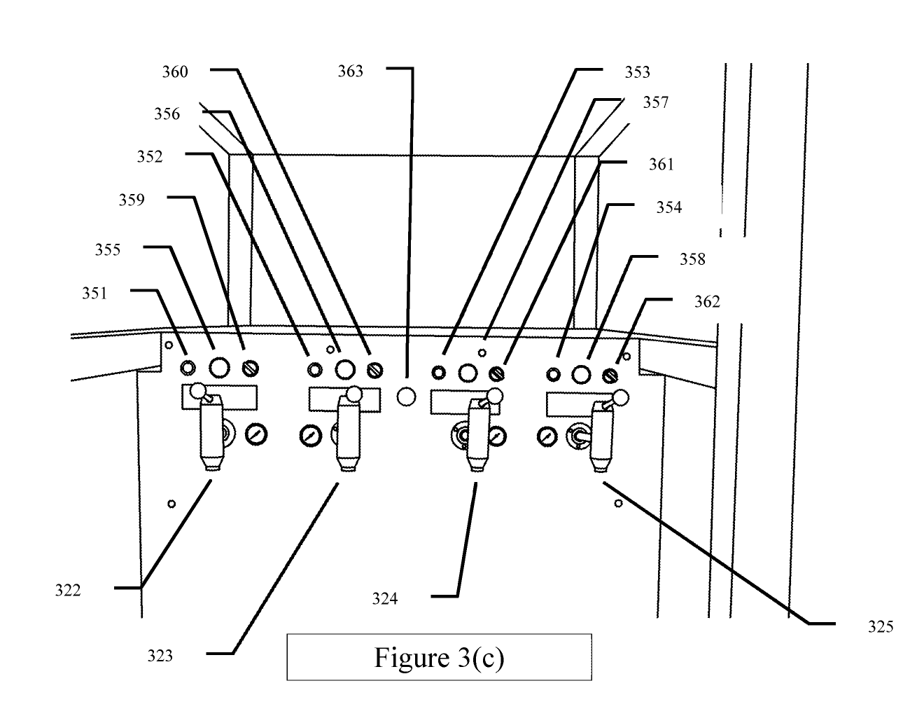

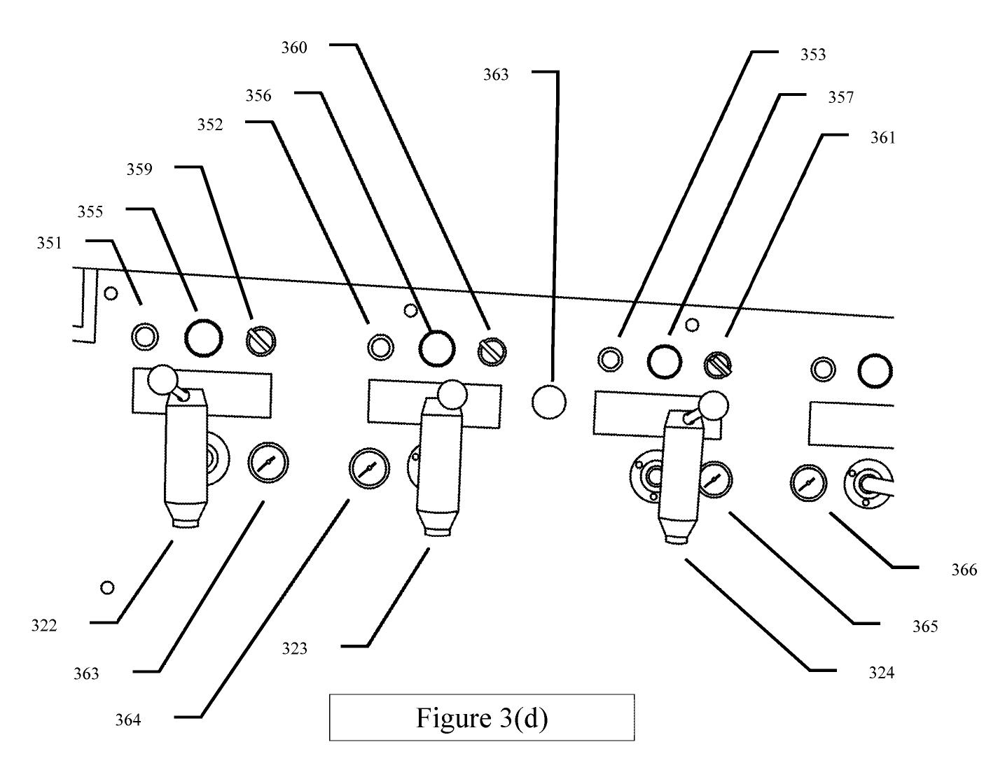

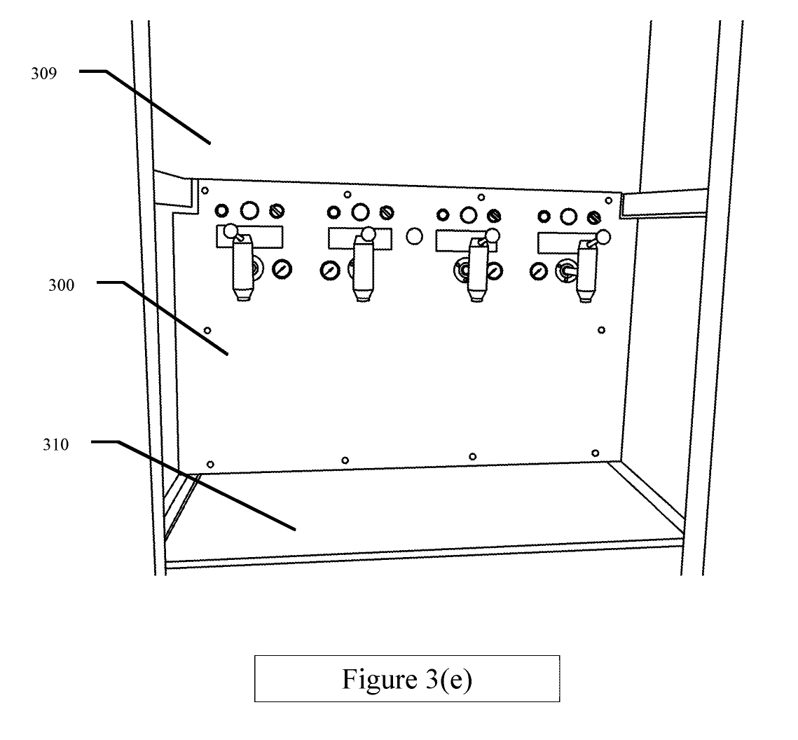

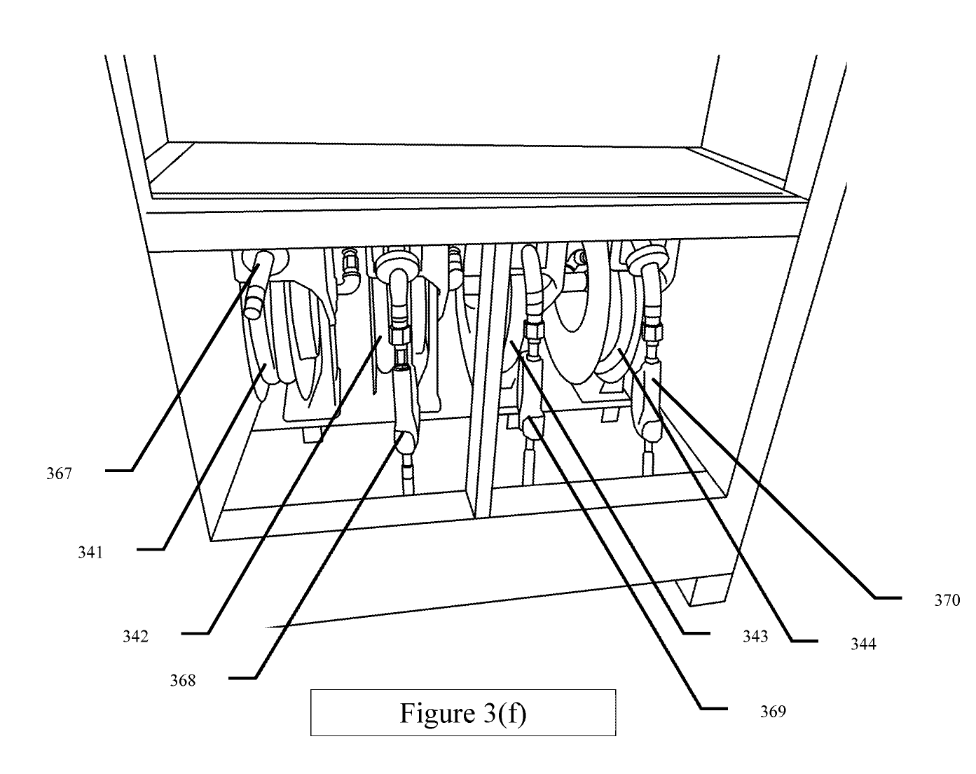

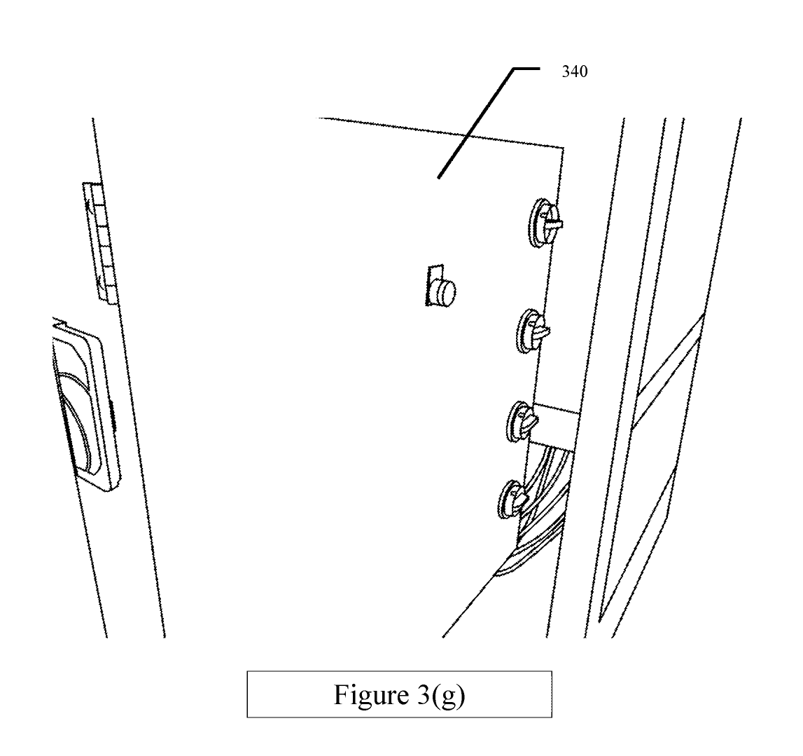

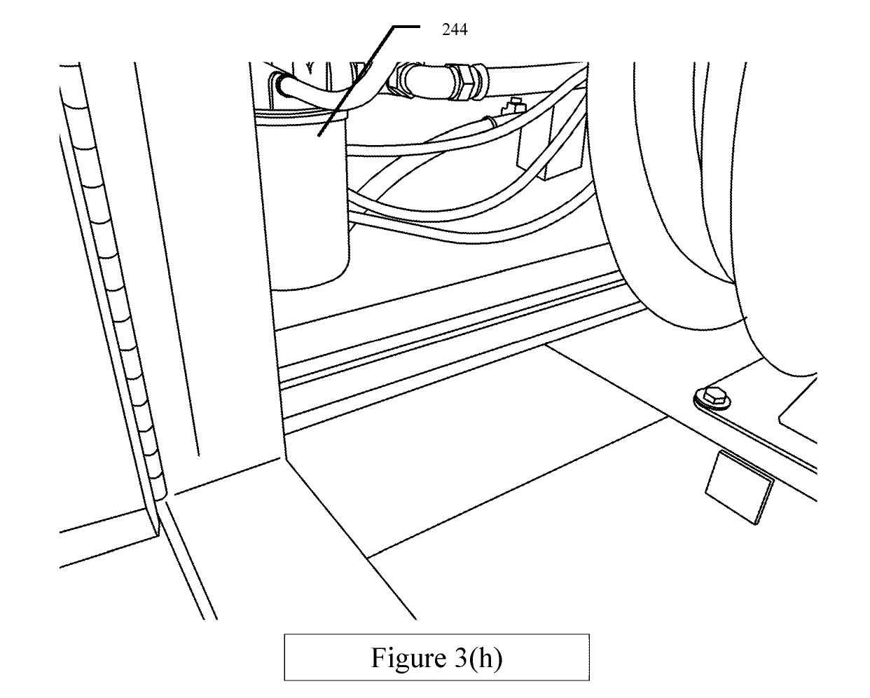

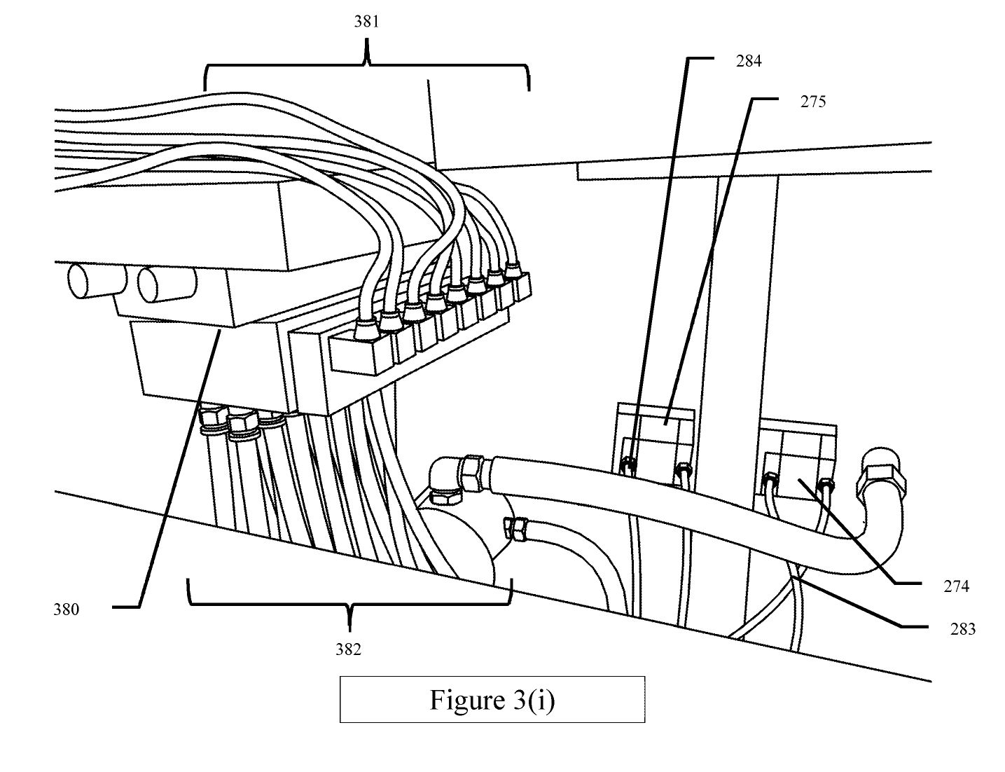

FIG. 3(a) depicts a perspective view of a fluid dispensing module 104. Exemplary fluid dispensing module 104 comprises a frame 302, bottom portion 303, top portion 304, cabinet portion 305, and spill grating 310.

Frame 302 comprises a bottom portion 303 configured to receive the forks of a forklift. The exemplary bottom portion 303 shown is configured to receive forks from any of its four sides. Cabinet portion 305 has cabinet doors 306 and 307. The top portion comprises a spill grating 310 that allows fluid to fall through to a spill pan below.

In an exemplary embodiment, fluid dispensing module 104 can be shipped pre-assembled as discussed above with reference to FIGS. 1(a) and 2(a).

FIG. 3(b) depicts a close-up front view of an exemplary top portion 304 of a fluid dispensing module 104 having a fluid dispensing panel 300 comprising four fluid dispensing taps 322-325, and four tap labels 326-329. In the exemplary embodiment of FIG. 3(b), one fluid can be dispensed by operation of each tap. Each tap label 326-329 indicates the fluid corresponding to the associated tap. In the embodiment of FIG. 3(b), each tap comprises a tap handle 330-333 and a tap knob 334-337. In an exemplary embodiment, each tap label, tap handle, and tap knob is colored according to the fluid identification convention for the corresponding fluid. Each tap label is also preferably marked with a shape according to the fluid identification convention. In an exemplary embodiment, all hoses are connected by hydraulic JIC fittings.

FIGS. 3(c) depicts a top portion 304 of exemplary fluid dispensing module 104. For each tap 322-325, fluid dispensing module 104 comprises 3 switches. For each tap, there is a corresponding start button 351-354 that is operable to remotely activate the corresponding pump for the corresponding storage container to allow fluid to be dispensed. For each tap, there is a corresponding stop button 355-358 that is operable to remotely deactivate the corresponding pump to stop dispensing. In the exemplary embodiment of FIG. 3(c), the divertor valves for each of the 4 pumps are pneumatically operated via 4 corresponding path selector switches 259-262. For each tap, there is a corresponding path selector switch 359-362 that can be set to one of 3 positions, each position corresponding to one of the user-selectable pump paths (i.e. intake, recirculate, or dispense). In an exemplary embodiment, when a switch is set to dispense mode, fluid is delivered to the corresponding fluid dispensing tap (e.g. 322-325) as well as the corresponding fluid dispensing hose (e.g. 341-344). Fluid is then dispensed by operating the corresponding tap handle or the corresponding hose trigger, as described herein. Button 363 is an emergency stop button that remotely deactivates all pumps.

FIG. 3(d) depicts a top portion 304 of exemplary fluid dispensing module 104. For each tap 322-325 there is a corresponding fluid pressure gauge 363-366. In an exemplary embodiment, each fluid pressure gauge displays the line pressure on the intake side of the filter for the corresponding pump.

FIG. 3(e) depicts top portion 304 of exemplary fluid dispensing module 104 including an exemplary arrangement having a shelf 309 for general storage and a perforated spill grating 310 that allows spilled fluid to fall through and into a drain pan within the fluid dispensing module. In an exemplary embodiment, there is a drain pan located immediately under the spill grating 310. In an exemplary embodiment, the drain pan has a ½″ threaded port in the base to which a drain hose may be coupled to thereby drain any spilled fluid through the drain hose and down into the underlying spill containment pan or to a secondary catch container.

FIG. 3(f) depicts a bottom portion of a fluid dispensing module having a cabinet portion 305, the cabinet portion (shown in FIG. 3(f) with the cabinet doors in an open position) having 4 retractable hoses 341-344, and 4 corresponding hose labels 345-348. In an exemplary embodiment, one fluid can be dispensed from each hose by operation of corresponding hose trigger 367-370 when the corresponding pump is activated. In an exemplary embodiment, each hose label is colored and marked with a shape according to the fluid identification convention for the corresponding fluid. In an exemplary embodiment, each hose, hose nozzle, hose trigger, and hose reel may be color coded and/or labelled according to the fluid identification convention.

FIG. 3(g) depicts a rear view of an exemplary fluid dispensing module comprising electrical enclosure 340. Electrical enclosure 340 encloses the various electrical components such as circuit breakers, motor overload protection, and low voltage power supply.

FIG. 3(h) depicts a right perspective view of an exemplary fluid dispensing module and an exemplary fluid storage module.

FIG. 3(i) depicts a side view of an exemplary fluid dispensing module. In an exemplary embodiment, the divertor valves for each pump are operated pneumatically and the system, e.g. fluid dispensing module 104, comprises a solenoid set 380. Exemplary solenoid set 380 is electrically connected to a plurality of selector switches via electrical connections 381 (e.g. selector switches 355-358) and pneumatically connected to a plurality of director valves via pneumatic connections 382. Thus, solenoid set 380 allows the electrically connected selector switches to control the actuation of the corresponding pneumatically connected director valves, and thus to control the user-selectable pump path for the corresponding pump. For example, user operation of selector switch 355 may be operable to electrically activate the solenoid set to pneumatically activate divertor valve 274 to thereby set the pump path for pump 211 and corresponding fluid storage container 207 to recirculate mode.

Equipment Storage Module

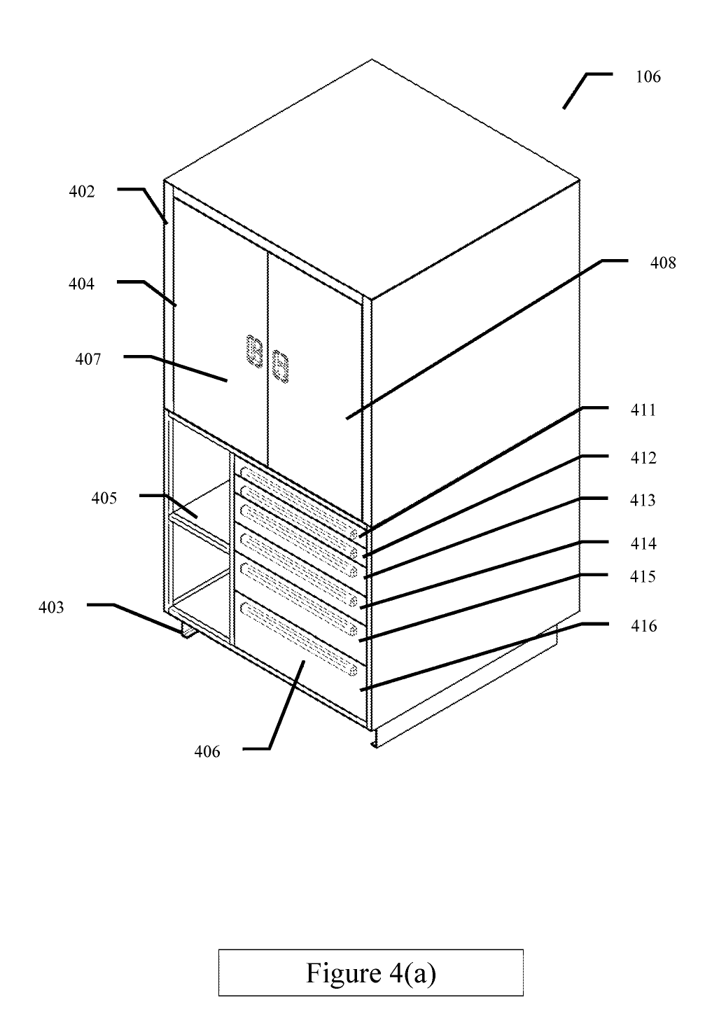

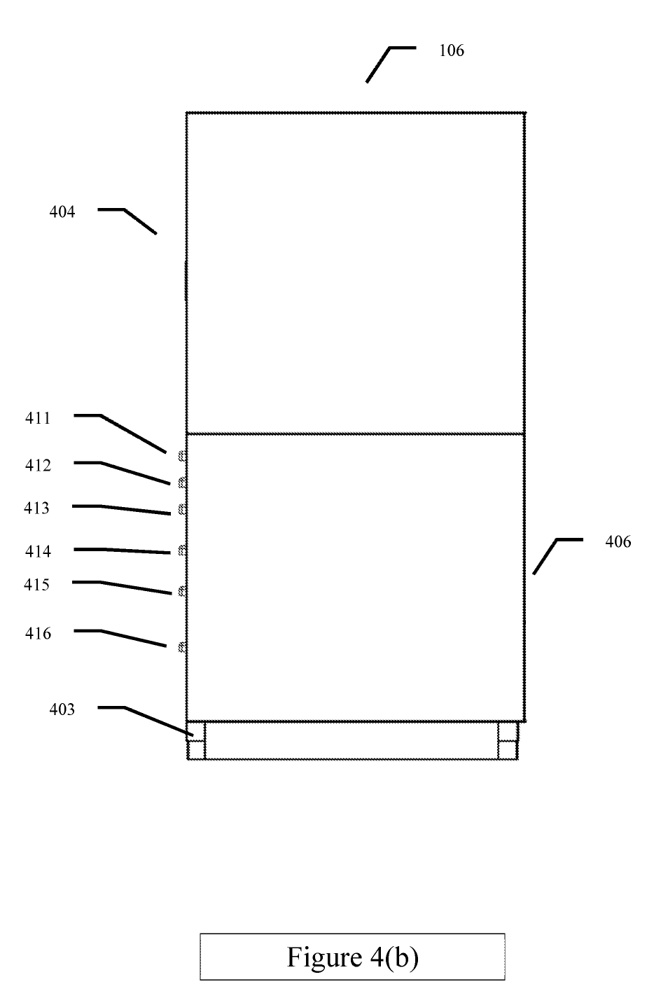

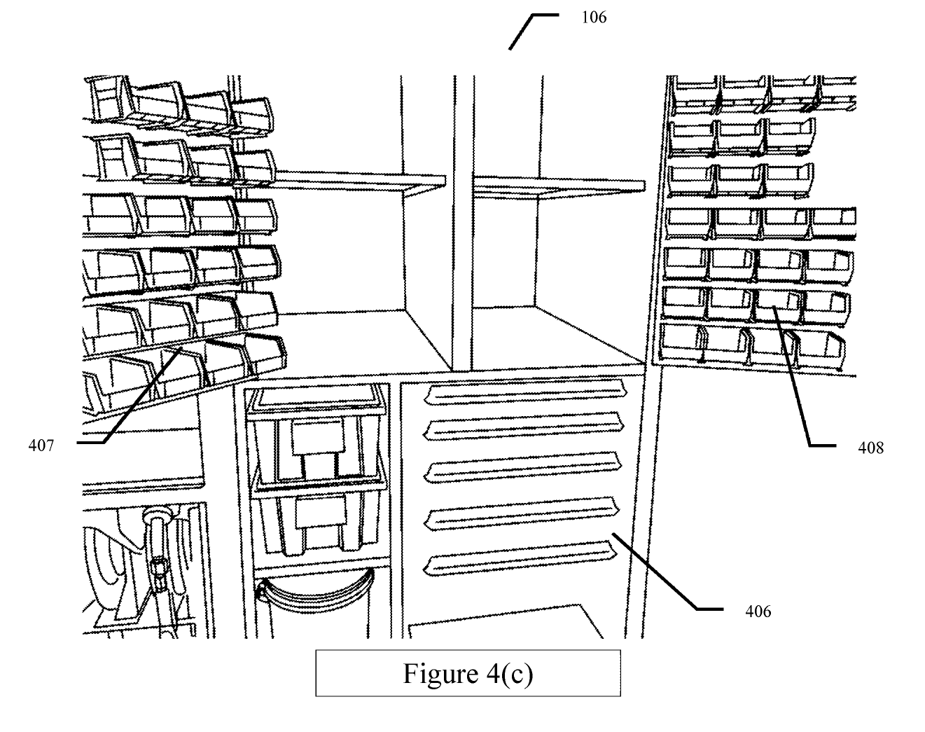

FIG. 4(a) depicts a perspective view of an exemplary equipment storage module 106. FIG. 4(b) depicts a side view of exemplary equipment storage module 106.

Exemplary equipment storage module 106 comprises a frame 402, bottom portion 403, cabinet portion 404, shelf portion 405, and drawer portion 406.

Frame 402 comprises a bottom forklift portion 403 configured to receive the forks of a forklift. The exemplary bottom forklift portion shown is configured to receive forks from the front and rear of the module 106.

Cabinet portion 404 comprises two cabinet doors 407 and 408. Shelf section 405 comprises shelves 409 and 410. Chest of drawers section 406 comprises roll-out drawers 411-416.

FIG. 4(c) depicts exemplary equipment storage module 106 with cabinet doors 407 and 408 in an open position. The interior of cabinet portion 404 comprises shelves 421 and 422. The interior side of cabinet doors 407 and 408 each comprise a plurality of connected storage bins 423 and 424.

It will be apparent that virtually any combination of shelves, drawers, and/or cabinets is possible for various different embodiments of equipment storage module 106.

Basic Fluid Storage and Dispensing Module

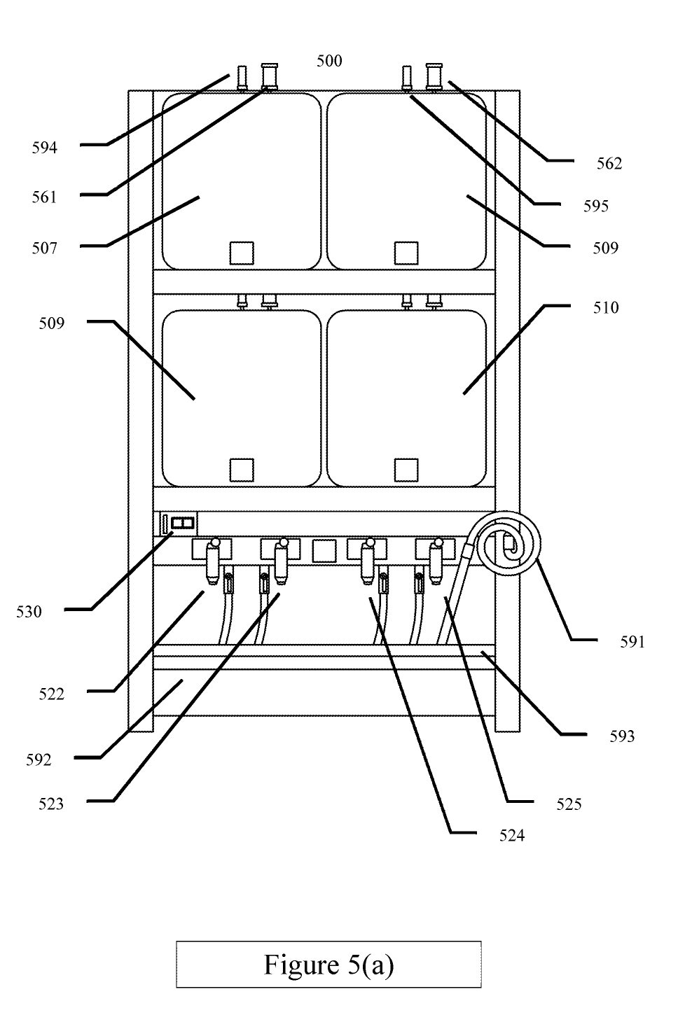

FIG. 5(a) depicts an exemplary basic fluid storage and dispensing module 500. Basic fluid storage and dispensing module 500 comprises a plurality of fluid storage containers 507-510, a plurality of color-coded dispenser taps 522-525, a plurality of color-coded tap labels 526-529 (colored and labelled according to a fluid identification convention), one pump 511, one filter 541, one switch 530 for selecting a fluid storage container for pump intake, an integrated suction hose holder 591, integrated spill pallet 592 and removable drop tray 593. Each fluid storage container 507-510 comprises an opening for accepting a vertical fluid level gauge 594-597 and desiccant air breather 561-564.

The exemplary basic fluid storage and dispensing module makes use of one pump that is selectably connected to any one of the four fluid storage containers 507-510 at any time. The cost of the module is reduced by making use of only one pump and filter. The pump may be used for fluid intake only to pump fluid up the fluid storage containers 507-510. Fluid dispensing taps 522-525 may be gravity fed, i.e. without the assistance of a pump.

Advanced Fluid Storage and Dispensing Module

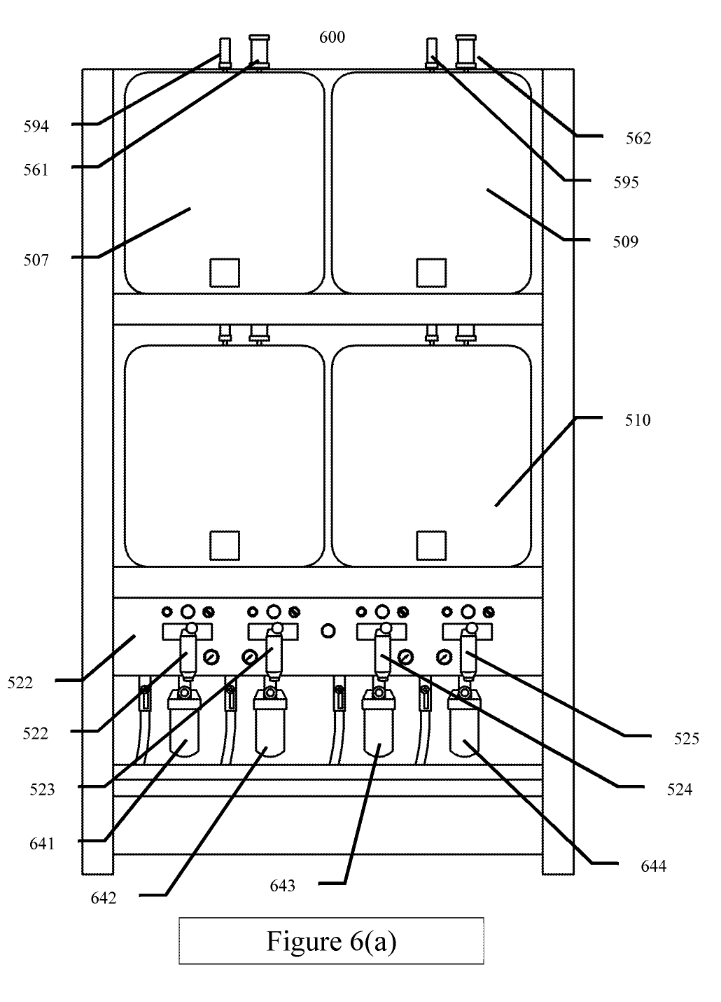

FIG. 6(a) depicts an exemplary advanced fluid storage and dispensing module 600. The advanced fluid storage and dispensing module comprises four fluid storage containers 507-510, each having a corresponding pump (not shown) and filter 641-644, and a corresponding tap 522-525. The advanced fluid storage and dispensing module 600 further comprises the electrical and pneumatic system necessary to activate the pumps via front panel 601. Front panel 601 is similar to the fluid dispensing panel 300 described in FIGS. 3(b)-3(e) in that it comprises 4 taps, 4 start buttons, 4 stop buttons, 4 path selector switches, and 4 fluid pressure gauges.

Suction Hose Storage

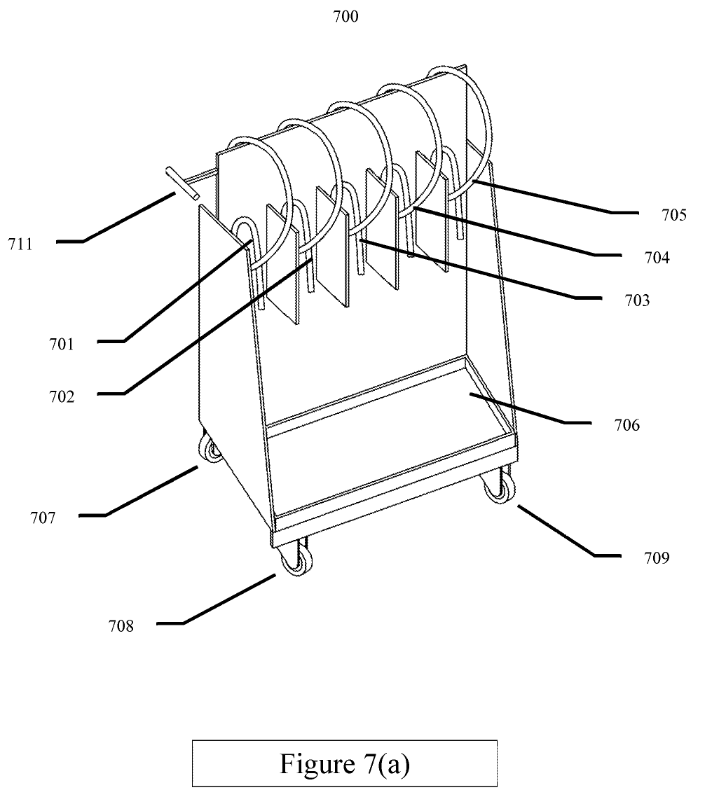

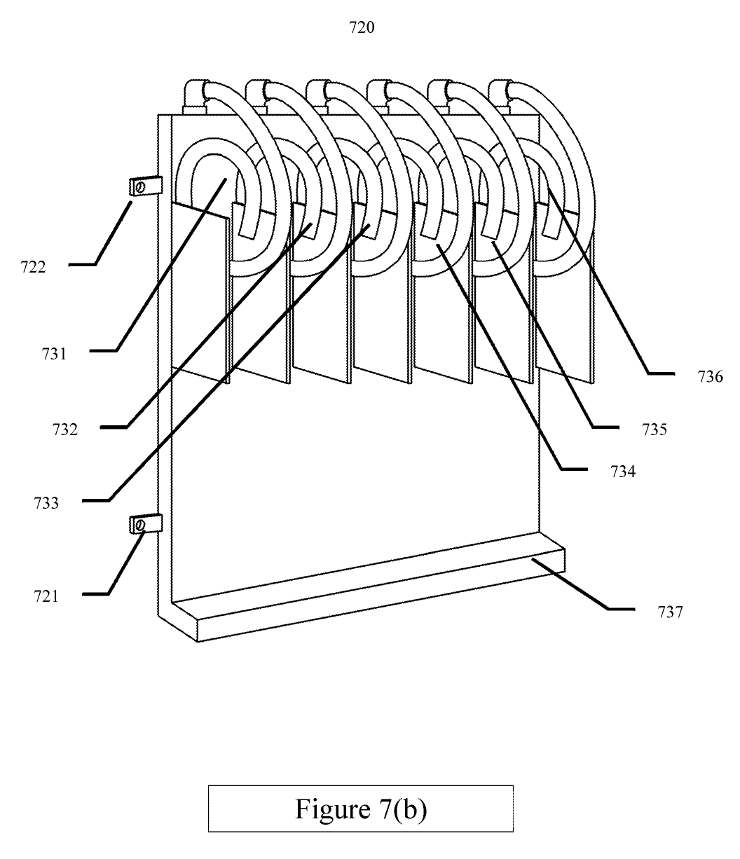

FIGS. 7(a) and 7(b) depict exemplary suction hose storage systems.

FIG. 7(a) depicts a mobile suction hose storage cart 700 having a plurality of suction hose holders 701-705, drip pan 706, wheels 707-710, and handle 711.

FIG. 7(b) depicts a mountable suction hose storage system 720 having mounting brackets 721-724 for mounting to a wall or to a module. Suction hose storage system 720 comprises suction hose holders 731-736, and drip pan 737.

Connected Spill Pans

FIG. 8(a) depicts a spill pan connector for connecting spill pans of multiple modules. According to an exemplary embodiment, a plurality of modules each comprises a base spill pan, and the base spill pans are connected. For example, two adjoining base spill pans may share a mating sidewall, and each base spill pan may comprise an overflow socket, lock nut, valve and/or gasket within the mating sidewall to allow fluid to flow between the base spill pans.

Accessories

Various accessories may be used with the modules of the present invention. For example, static discharge reels, fluid overflow alarms, suction hoses (telescoping or non-telescoping).

FIGS. 8(b) and 8(c) depict an exemplary static discharge reel that may be connected to, e.g., a fluid storage module. In an exemplary embodiment, the static discharge reel may be connected to a grounding wire, or an end-user grounding system as described in Appendices B and C.

In an exemplary embodiment, lifting lugs are connected (e.g., bolted or welded) to the frame, e.g. to the top of the frame, so that the module can be moved by way of an overhead crane. Lifting lugs may be useful, for example, if loading the module onto a ship, moving the module within a workshop using an overhead gantry, or lowering the unit down into a factory basement level.

In an exemplary embodiment, levelling feet are provided on each of the four vertical uprights on each module. Each vertical upright may comprise a threaded nut on the bottom, and each levelling foot may comprise threaded bolts that bolt into the nut.

While the present invention has been described above in relation to its preferred embodiments, various modifications may be made thereto that still fall within the invention's scope as will be recognizable upon review of the teachings herein. As such, the full scope of the present invention is to be defined solely by the appended claims and their legal equivalents.

What is claimed is:

1. A modular system for managing the storage and dispensing of a plurality of fluids, the system comprising:
a plurality of modules that are movable within the system, the modules comprising at least two members of the group consisting of (1) a module configured to store at least one type of fluid, (2) a module configured to dispense at least one type of fluid, (3) a module configured to store and dispense at least one type of fluid, and (4) a module configured to store equipment.

2. The system of claim 1 wherein the plurality of modules comprises the module that is configured to store at least one type of fluid, that module comprising (1) a plurality of storage containers for storing a plurality of fluid types, (2) a pump system, and (3) a plurality of fluid intake ports, wherein the pump system is configured to pump fluid from an external source to one of the storage containers through one of the fluid intake ports.

3. The system of claim 2 wherein the plurality of modules further comprises the module that is configured to dispense at least one type of fluid, that module comprising a plurality of taps, the taps for interconnection with the pump system to permit a flow of a first fluid type from a first of the storage containers through a first of the taps and a flow of a second fluid type from a second of the storage containers through a second of the taps.

4. The system of claim 1 wherein the plurality of modules further comprises the module that is configured to store and dispense at least one type of fluid, that module comprising (1) a plurality of storage containers for storing a plurality of fluid types, (2) a pump system, (3) a plurality of fluid intake ports, and (4) a plurality of taps, the taps for interconnection with the pump system to permit a flow of a first fluid type from a first of the storage containers through a first of the taps and a flow of a second fluid type from a second of the storage containers through a second of the taps;
wherein the pump system is configured to pump fluid from an one an external source to one of the storage containers through one of the fluid intake ports.

5. The system of claim 1 wherein the plurality of modules further comprises an equipment storage module, the equipment storage module abutting at least one of the fluid storage module and the fluid dispensing module.

6. The system of claim 1 further comprising a suction hose storage module comprising a drip pan and a plurality of holders for holding a suction hose.

7. A method comprising:
transporting an assembled module in assembled form, the module comprising (1) a frame having a lower portion configured to receive at least one fork of a forklift, and (2) at least two members of the group consisting of a fluid storage container, a pump, a fluid dispensing tap, and a fluid dispensing hose.

8. The method of claim 7 wherein the transporting comprises:
lifting the assembled module using a forklift.

9. The method of claim 8 wherein the transporting further comprises:
moving the assembled module to a truck via the forklift for subsequent delivery of the assembled module to a customer in pre-assembled form.

10. An apparatus for storing a fluid, the apparatus comprising:
a frame having an upper portion and a lower portion;
a fluid storage container connected to the upper portion of the frame; and
wherein the lower portion of the frame is configured to receive at least one fork of a forklift to thereby permit lifting and movement of the apparatus as a single piece.

11. The apparatus of claim 10 further comprising a pump, a filter, and a pump caddy, wherein the pump is mounted to the pump caddy, and wherein the pump caddy is releasably mounted to the lower portion of the frame.

12. The apparatus of claim 10 wherein the lower portion of the frame is configured to receive two forks of a forklift.

13. The apparatus of claim 10 comprising a plurality of fluid storage containers.

14. The apparatus of claim 13 comprising a plurality of fluid storage containers of different sizes.

15. The apparatus of claim 13 wherein each of the plurality of storage containers is color-coded to identify a fluid type for that container.

16. The apparatus of claim 15 wherein each container comprises a container label affixed thereon, the label exhibiting the color-coding and further exhibiting a shape that identifies a fluid type for that container in combination with the color-coding.

17. The apparatus of claim 10 wherein the lower portion of the frame comprises a spill pan.

18. The apparatus of claim 11 wherein the apparatus is adapted for shipping with the fluid storage container and the pump caddy connected to the frame.

19. The apparatus of claim 10 wherein the frame comprises an open side to permit connector hoses to pass through.

20. The apparatus of claim 10 wherein the frame comprises two open sides to permit connector hoses to pass through.

21. The apparatus of claim 11 further comprising an intake connector connected to the pump and the fluid storage container, and wherein the pump is operable to pump fluid from the intake connector into the fluid storage container.

22. The apparatus of claim 11 wherein the apparatus comprises a plurality of fluid storage containers and a plurality of pumps connected to the frame, and wherein each pump is connected to exactly one fluid storage container.

23. The apparatus of claim 10 further comprising a pump and a fluid dispensing tap, wherein the pump is operable to pump fluid from the fluid storage container to the fluid dispensing tap.

24. The apparatus of claim 10 further comprising a pump and a fluid dispensing hose, wherein the pump is operable to pump fluid from the fluid storage container to the fluid dispensing hose.

25. The apparatus of claim 10 further comprising a retractable static discharge reel connected to the frame.

26. An apparatus for dispensing fluid, the apparatus comprising:
a frame having a upper portion and a lower portion;
a plurality of fluid dispensing taps located in the upper portion of the frame; and
wherein the lower portion of the frame is configured to receive at least one fork of a forklift to thereby permit lifting and movement of the apparatus as a single piece.

27. The apparatus of claim 26 wherein the lower portion of the frame is configured to receive two forks of a forklift.

28. The apparatus of claim 26 further comprising a plurality of fluid dispensing hoses located in the lower portion of the frame.

29. The apparatus of claim 26 further comprising:
a plurality of tap labels, each tap label corresponding to one of the plurality of fluid dispensing taps;
wherein each tap label comprises a unique tap label color and a unique tap label shape;
wherein each of the plurality of fluid dispensing taps comprises a handle having a handle color and a knob having a knob color; and
wherein the handle color, knob color, and tap label color associated with each tap are the same color.

30. The apparatus of claim 29 wherein the lower portion of the frame further comprises a cabinet portion located below the fluid dispensing taps, the cabinet portion comprising a door and an interior portion, the interior portion having a plurality of fluid dispensing hoses mounted therein, each fluid dispensing hose being associated with a fluid;
wherein the interior portion further comprises a plurality of hose labels, each hose label corresponding to one of the plurality of fluid dispensing hoses;
wherein each hose label comprises a unique hose label color and a unique hose label shape; and
wherein the handle color, knob color, tap label color, and hose label color associated with the same fluid are the same color, and wherein the tap label shape and hose label shape associated with the same fluid are the same shape.

31. The apparatus of claim 26 wherein the lower portion of the frame comprises a spill pan.

32. The apparatus of claim 28 wherein the apparatus is adapted for shipping with the fluid dispensing taps and the fluid dispensing hoses connected to the frame.

33. The apparatus of claim 26 wherein the frame comprises an open side to permit connector hoses to pass through.

34. The apparatus of claim 26 wherein the frame comprises two open sides to permit connector hoses to pass through.

35. The apparatus of claim 26 further comprising circuitry for communicating with a pump to enable dispensing of fluid.

36. The apparatus of claim 35 wherein each tap comprises a tap handle that is operable to activate the circuitry and thereby cause fluid to be dispensed from the corresponding tap.

37. The apparatus of claim 26 further comprising a pump and a fluid storage container, wherein the pump is operable to pump fluid from the fluid storage container to one of the fluid dispensing taps.

38. The apparatus of claim 28 further comprising a pump and a fluid storage container, wherein the pump is operable to pump fluid from the fluid storage container to one of the fluid dispensing hoses.

39. An apparatus comprising:
a frame;
a fluid storage container connected to the frame;
a pump system connected to the frame;
a fluid intake port connected to the frame;
a filter connected to the frame; and
wherein the pump is configured to pump fluid from the fluid intake port to the fluid storage container via the filter.

40. An apparatus comprising:
a frame;
a fluid storage container connected to the frame;
a pump system connected to the frame;
a fluid intake port connected to the frame;
a filter connected to the frame; and
a air breather connected to the fluid storage container.

41. An apparatus comprising:
a frame;
a fluid storage container connected to the frame;
a pump system connected to the frame;
a fluid intake port connected to the frame; and
at least one fluid dispensing member selected from the group consisting of a fluid dispensing tap and a fluid dispensing hose.

42. An apparatus comprising:
a frame;
a fluid storage container connected to the frame;
a pump system connected to the frame;
a fluid intake port connected to the frame; and
a spill pan connected to the lower portion of the frame.

43. An apparatus comprising:
a frame;
a fluid storage container connected to the frame;
a pump system connected to the frame;
a fluid intake port connected to the frame; and
a static discharge reel connected to the frame.

44. An apparatus comprising:
a frame;
at least one fluid dispensing member connected to the frame, the fluid dispensing member selected from the group consisting of a fluid dispensing tap and a fluid dispensing hose;
a pneumatic system operable to actuate a divertor valve and connected to the frame; and
an electrical switch for activating the pneumatic system.

45. A system comprising:
a plurality of stand-alone modules;
a fluid storage container and at least one fluid dispensing member selected from the group consisting of a fluid dispensing tap and a fluid dispensing hose;
a plurality of base spill pans, wherein each base spill pan is connected to one of the modules in the plurality of modules;
wherein the plurality of base spill pans are connected, thereby allowing fluid to flow there between.

46. The system of claim 45 wherein at least two of the plurality of base spill pans are connected via an overflow connector.

47. An apparatus comprising:
a frame having an upper portion and a lower portion;
at least two members selected from the group consisting of (1) a fluid storage container, (2) a pump, (3) a fluid dispensing tap, and (4) a fluid dispensing hose;
a lifting lug connected to the frame;

48. A lubrication work center comprising:
a fluid storage module comprising:
a plurality of fluid storage containers, each container corresponding to a type of fluid, each container comprising a colored portion having a container color, and each container having a container label affixed thereon;
wherein each container label comprises a container label color and a container label shape, wherein the container label color is the same as the corresponding container color;
a fluid dispensing module comprising:
a plurality of fluid dispensing taps, each fluid dispensing tap corresponding to one of the fluid storage containers, each fluid dispensing tap comprising a colored portion having a tap color, and having a corresponding tap label;
wherein each tap label comprises a tap label color and a tap label shape, the tap label color being the same as the corresponding tap color;
wherein each tap label color is the same as the corresponding container label color; and
wherein each tap label shape is the same as the corresponding container label shape.

49. The lubrication work center of claim 48 wherein the fluid dispensing module further comprises a plurality of fluid dispensing hoses, each fluid dispensing hose corresponding to one of the fluid storage containers, each fluid dispensing hose having a corresponding hose label;
wherein each hose label comprises a hose label color and a hose label shape;
wherein each hose label color is the same as the corresponding container label color; and
wherein each hose label shape is the same as the corresponding container label shape.

50. The lubrication work center of claim 48 further comprising an equipment storage module, the equipment storage module comprising a plurality of shelves and a plurality of drawers.
